(19) United States
(12) Patent Application Publication
(10) Pub. No.: US 2021/0357752 A1
(43) Pub. Date: Nov. 18, 2021

(54) Model Processing Method, Apparatus, Storage Medium, and Processor

(71) Applicant: Alibaba Group Holding Limited, Grand Cayman (KY)

(72) Inventors: Daoyuan Chen, Hangzhou (CN); Yaliang Li, Bellevue, WA (US); Minghui Qiu, Hangzhou (CN); Zhen Wang, Hangzhou (CN); Bofang Li, Hangzhou (CN); Bolin Ding, Redmond, WA (US); Hongbo Deng, Hangzhou (CN); Jun Huang, Hangzhou (CN); Wei Lin, Hangzhou (CN); Jingren Zhou, Bellevue, WA (US)

(21) Appl. No.: 17/313,772

(22) Filed: May 6, 2021

(30) Foreign Application Priority Data
May 15, 2020 (CN) 202010413915.0

(51) Int. Cl. G06N 3/08; G06F 40/20; G06N 3/04

(52) U.S. Cl. CPC G06N 3/08; G06N 3/04; G06F 40/20

(57) ABSTRACT

A method, an apparatus, a storage medium, and a processor for model processing are disclosed. The method includes: obtaining an original language model; determining a task that needs to be processed by the original language model; and converting the original language model based on features of the task to obtain a target language model for processing the task. The present disclosure solves the technical problem of the difficulty of effectively using a model.

### CROSS REFERENCE TO RELATED PATENT APPLICATIONS

This application claims priority to Chinese Application No. 202010413915.0, filed on 15 May 2020 and entitled “Model Processing Method, Apparatus, Storage Medium, and Processor,” which is hereby incorporated by reference in its entirety.

### TECHNICAL FIELD

The present disclosure relates to the field of computers, and particularly to model processing methods, apparatuses, storage media, and processors.

### BACKGROUND

At present, language models can be applied to various natural language processing tasks. However, if these models are learned from a massive number of data sets, with parameters usually being on the order of one billion, it is very difficult to directly deploy such large-scale models on real-time applications where computing resources and inference times are strictly limited, making it difficult to effectively use the models.

In view of the above-mentioned technical problem that it is difficult to effectively use a model, no effective solution has been proposed.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

Embodiments of the present disclosure provide a method, an apparatus, a storage medium, and a processor for model processing, so as to at least solve the technical problem of the difficulty of effectively using a model.

According to the embodiments of the present disclosure, a model processing method is provided. The method may include: obtaining an original language model; determining a task that needs to be processed by the original language model; and converting the original language model based on feature(s) of the task to obtain a target language model for processing the task.

According to the embodiments of the present disclosure, another model processing method is also provided. The method may include: obtaining textual information uploaded to a target platform; determining a task corresponding to the textual information, wherein the task is processed by an original language model, and a target language model is obtained by converting the original language model based on feature(s) of the task; processing the textual information to obtain a textual processing result based on the target language model; and outputting the textual processing result to the target platform.

According to the embodiments of the present disclosure, another model processing method is also provided. The method may include: receiving textual input information, where the textual input information is collected based on at least one text collector associated with a textual processing system; determining a task corresponding to the textual input information, and reading a target language model, wherein the task is processed by an original language model, and the target language model is obtained by converting the original language model based on feature(s) of the task; processing the textual input information based on the target language model to obtain a textual processing result; and outputting the textual processing result.

According to the embodiments of the present disclosure, another model processing method is also provided. The method may include: obtaining an original language model in response to a target request sent by a client, wherein the target request includes a task that needs to be processed by the original language model; converting the original language model based on feature(s) of the task to obtain a target language model; and sending the target language model to the client, wherein the target language model is used to process the task on the client.

According to the embodiments of the present disclosure, another model processing method is also provided. The method may include: obtaining an original language model; determining a task that needs to be processed by the original language model when the original language model meets a target condition, and converting the original language model based on feature(s) of the task to obtain a target language model for processing the task; and prohibiting the original language model from being converted when the original language model does not meet the target condition.

According to the embodiments of the present disclosure, another model processing method is also provided. The method may include: obtaining an original language model; determining a task that needs to be processed by the original language model, and sending a configuration template associated with feature(s) of the task to a client; obtaining configuration parameter(s) obtained by the client based on the configuration template, and converting the original language model based on the original configuration parameter(s) to obtain a target language model for processing the task.

According to the embodiments of the present disclosure, a model processing apparatus is also provided. The apparatus may include: a first acquisition unit used for obtaining an original language model; a first determination unit used for determining a task that needs to be processed by the original language model; and a conversion unit used for converting the original language model based on features of the task to obtain a target language model used to process the task.

According to the embodiments of the present disclosure, another model processing apparatus is also provided. The apparatus may include: a second acquisition unit used for obtaining textual information uploaded to a target platform; a second determination unit used for determining a task corresponding to the textual information, wherein the task is processed by the original language model, and a target language model is obtained by converting the original language model based on feature(s) of the task; a first processing unit used for processing textual input information based on the target language model to obtain a textual processing result; and a first output unit used for outputting the textual processing result to the target platform.

According to the embodiments of the present disclosure, another model processing apparatus is also provided. The apparatus may include: a receiving unit used for receiving textual input information, wherein the textual input information is collected based on at least one text collector associated with a textual processing system; and a third determination unit used for determining that a task corresponds to the textual input information and reading a target language model, wherein the task is processed by the original language model, and the target language model is obtained by converting the original language model based on feature(s) of the task; a second processing unit used for processing the textual input information using the target language model to obtain a textual processing result; and a second output unit used for outputting the textual processing result.

According to the embodiments of the present disclosure, a storage medium is also provided. The storage medium includes a stored program, wherein a device where the storage medium is located is controlled to perform the following steps when the program is run by a processor: obtaining an original language model; determining a task that needs to be processed by the original language model; and converting the original language model based on feature(s) of the task to obtain a target language model for processing the task.

According to the embodiments of the present disclosure, a processor is also provided. The processor is used to run the program, where the following steps are performed when the program is running: obtaining an original language model; determining a task that needs to be processed by the original language model; and converting the original language model based on feature(s) of the task to obtain a target language model for processing the task.

According to the embodiments of the present disclosure, a mobile terminal is also provided. The mobile terminal includes: a processor; a memory coupled to the processor and used for providing the processor with instructions for processing the following processing steps: obtaining an original language model; determining a task that needs to be processed by the original language model; and converting the original language model based on feature(s) of the task to obtain a target language model for processing the task.

In the embodiments of the present disclosure, an original language model is obtained. A task to be processed by the original language model is determined, and the original language model is converted based on feature(s) of the task to obtain a target language model for processing the task. In other words, the present application automatically compresses an original language model into adaptive target language models based on different tasks, which can also be easily implemented when deployed in real-time applications that have strict limitations on computing resources and inference times. This thereby improves the effectiveness of the compression of the original language model on multiple tasks, solves the technical problem of the difficulty of effectively using a model, and achieves a technical effect of making an effective use of the model.

### BRIEF DESCRIPTION OF THE DRAWINGS

Accompanying drawings described herein are used to provide a further understanding of the present disclosure and constitute a part of the present application. Exemplary embodiments of the present disclosure and a description thereof are used to explain the present disclosure, and do not constitute an improper limitation of the present disclosure. In the accompanying drawings:

FIG. 1 shows a block diagram of a hardware structure of a computer terminal (or a mobile device) used to implement a model processing method.

FIG. 2 is a flowchart of a model processing method according to an embodiment of the present disclosure.

FIG. 3 is a flowchart of another model processing method according to an embodiment of the present disclosure.

FIG. 4 is a flowchart of another model processing method according to an embodiment of the present disclosure.

FIG. 5 is a schematic diagram of a BERT model compression according to an embodiment of the present disclosure.

FIG. 6 is a schematic diagram of a knowledge decomposer according to an embodiment of the present disclosure.

FIG. 7 is a schematic diagram of a model processing apparatus according to an embodiment of the present disclosure.

FIG. 8 is a schematic diagram of another model processing apparatus according to an embodiment of the present disclosure.

FIG. 9 is a schematic diagram of another model processing apparatus according to an embodiment of the present disclosure.

FIG. 10 is a structural block diagram of a mobile terminal according to an embodiment of the present disclosure.

### DETAILED DESCRIPTION

In order to enable one skilled in the art to better understand the solutions of the present disclosure, technical solutions in the embodiments of the present disclosure will be described clearly and completely hereinafter in conjunction with the accompanying drawings in the embodiments of the present disclosure. Apparently, the described embodiments merely represent some and not all of the embodiments of the present disclosure. Based on the embodiments of the present disclosure, all other embodiments obtained by one of ordinary skill in the art without making any creative effort shall fall within the scope of protection of the present disclosure.

It should be noted that the terms “first” and “second” in the specification and claims of the present disclosure and the above-mentioned drawings are used to distinguish similar objects, and not necessarily used to describe a specific order or sequence. It should be understood that data used in this way can be interchanged under appropriate circumstances so that the embodiments of the present disclosure described herein can be implemented in an order other than those illustrated or described herein. In addition, the terms “including” and “having” and any variations thereof are intended to cover non-exclusive inclusions. For example, a process, method, system, product, or device that includes a series of steps or units is not necessarily limited to those clearly listed, and may include other steps or units that are not clearly listed or that are inherent to such process, method, product, or device.

First, some nouns or terms that appear in the description of the embodiments of the present application are suitable for the following interpretations:

Bidirectional Encoder Representations from Transformers (abbreviated as BERT), which is based on a Transformer architecture, is a pre-training language model technology that achieves the most advanced performance, and is widely used in various natural language processing tasks.

Model Compression is a technology that compresses a large model with a large number of parameters and slow inference speed into a small model with a small number of parameters and fast inference speed.

Neural Architecture Search (abbreviated as NAS) is a technology for automatically designing artificial neural networks.

Differentiable Neural Architecture Search (abbreviated as DNAS) can support searching of a hierarchical search space.

Multi-Task Learning (Multi-Task Learning) is a machine learning technology that can solve multiple learning tasks at the same time while taking advantage of commonalities, differences, and complementarities between tasks.

According to an embodiment of the present disclosure, an embodiment of a model processing method is also provided. It should be noted that steps shown in a flowchart of an accompanying drawing can be executed in a computer system such as a set of computer-executable instructions. Moreover, although a logical order is shown in a flowchart, in some cases, steps may be performed in an order different from those that are shown or described herein.

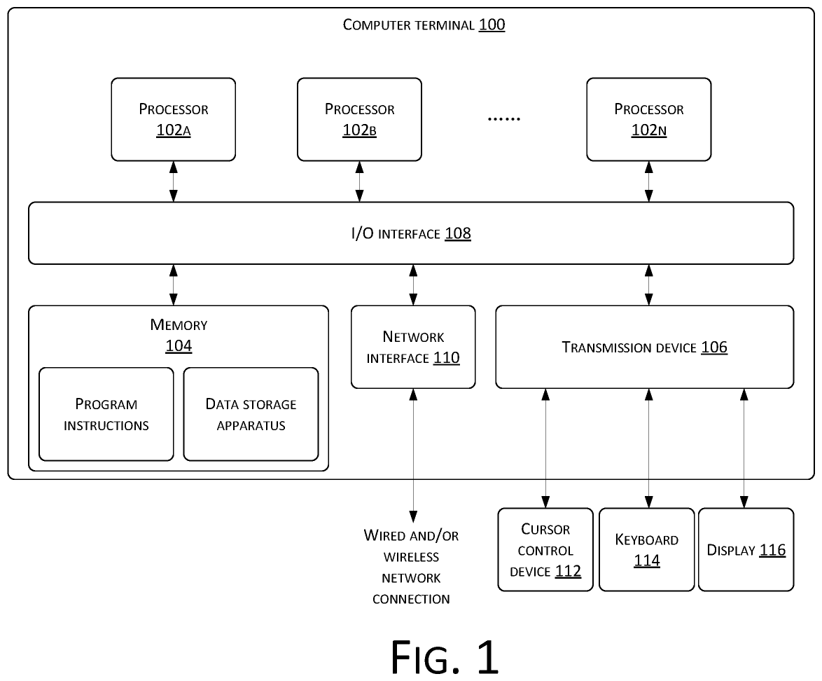

A method embodiment provided in the present application may be executed in a mobile terminal, a computer terminal, or a similar computing apparatus. FIG. 1 shows a block diagram of a hardware structure of a computer terminal (or a mobile device) for implementing the model processing method. As shown in FIG. 1, the computer terminal 100 (or the mobile device 100) may include one or more (shown as 102a, 102b, . . . , 102n in the figure) processors 102 (the processor 102 may include, but is not limited to, a processing device such as a micro-processor MCU or a programmable logic device FPGA, etc.), a memory 104 used for storing data, and a transmission device 106 used for communication functions. In addition, a display, an input/output interface (I/O interface) 108, a universal serial bus (USB) port (which may be included as one of the ports of the I/O interface), a network interface 110, a cursor control device 112, a keyboard 114, and a display 116 may also be included. In implementations, a power supply, and/or a camera (not shown in the figure) may also be included. One of ordinary skill in the art can understand that the structure shown in FIG. 1 is only illustrative, and does not limit the structure of the above electronic device. For example, the computer terminal 100 may also include more or fewer components than those shown in FIG. 1, or have a configuration different from that shown in FIG. 1.

It should be noted that the one or more processors 102 and/or other data processing circuits may generally be referred to as “data processing circuits” herein. Such data processing circuit can be embodied in whole or in part as software, hardware, firmware or any other combination. In addition, a data processing circuit may be a single independent processing module, or may be fully or partially integrated into any one of the other elements in the computer terminal 100 (or the mobile device). As described in the embodiments of the present application, the data processing circuit is used as a kind of processor control (for example, a selection of a variable resistance terminal path connected to an interface).

The memory 104 can be used to store software programs and modules of application software, such as program instructions/a data storage apparatus corresponding to the model processing method in the embodiments of the present disclosure. The processor 102 runs software programs and modules stored in the memory 104, thereby executing various functional applications and data processing, i.e., implementing the above-mentioned model processing method. The memory 104 may include a high-speed random access memory, and may also include a non-volatile memory, such as one or more magnetic storage devices, flash memory, or other non-volatile solid-state memory. In some examples, the memory 104 may further include a storage device that is remotely deployed with respect to the processor 102, and such storage device may be connected to the computer terminal 100 via a network. Examples of the network include, but are not limited to, the Internet, a corporate intranet, a local area network, a mobile communication network, and a combination thereof.

The transmission device 106 is used to receive or send data via a network. Specific examples of the network may include a wireless network provided by a communication provider of the computer terminal 100. In an example, the transmission device 106 includes a network adapter (Network Interface Controller, NIC), which can be connected to other network devices through a base station so as to communicate with the Internet. In an example, the transmission device 106 may be a radio frequency (RF) module, which is used to communicate wirelessly with the Internet.

The display 116 may, be a touch screen liquid crystal display (LCD), for example, which may enable a user to interact with a user interface of the computer terminal 100 (or the mobile device).

It should be noted herein that, in some alternative embodiments, the computer device (or mobile device) as shown in FIG. 1 may include hardware elements (including circuits) and software elements (including computer codes stored on a computer-readable medium), or a combination of hardware and software components. It should be noted that FIG. 1 is only one example of specific examples, and is intended to show the types of components that may be present in the above-mentioned computer device (or the mobile device).

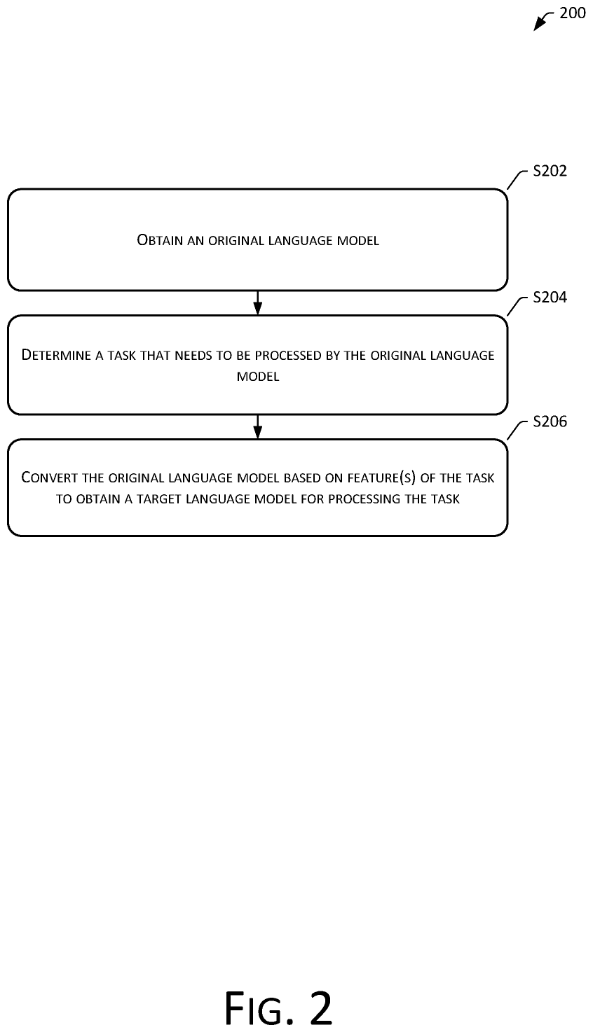

In an operating environment as shown in FIG. 1, the present application provides a model processing method as shown in FIG. 2. It should be noted that the model processing method in this embodiment can be executed by the mobile terminal of the embodiment as shown in FIG. 1.

FIG. 2 is a flowchart of a model processing method 200 according to an embodiment of the present disclosure. As shown in FIG. 2, the method 200 may include the following steps:

Step S202: Obtain an original language model.

In the technical solutions provided in step S202 of the present disclosure, a processing object of an original language model that is obtained is textual information (a natural language), which can be a pre-trained context characterization encoder, for example, a Bidirectional Encoder Representations from Transformers (abbreviated as BERT) model. Such BERT model can be applied to various natural language processing tasks. In implementations, an original language model of this embodiment is learned from a massive number of data sets, and their parameters are usually on the order of one billion, which can be called a large-scale model. When the original language model is a BERT model, it can also be called a large BERT model.

Step S204: Determine a task that needs to be processed by the original language model.

In the technical solutions provided in step S204 of the present disclosure, after obtaining the original language model, determining a task that needs to be processed by the original language model may be determining at least one task that needs to be processed by the original language model.

In this embodiment, one or more tasks corresponding to the original language model may exist. At least one task can be a natural language processing task. When there are multiple tasks, this can also be called multitasking. Learning tasks in Multi-Task Learning can also be different downstream tasks of the original language model.

In this embodiment, the original language model can learn a large number of different types of knowledge in a large-scale corpus, and different tasks can use the original language model in different ways. For example, when the original language model is a BERT model, it can learn a large number of different types of knowledge from a large-scale corpus, and different specific tasks can use the BERT model in different ways.

Step S206: Convert the original language model based on feature(s) of the task to obtain a target language model for processing the task.

In the technical solutions provided in the above step S206 of the present disclosure, after determining the task that needs to be processed by the original language model, the original language model is converted based on feature(s) of the task to obtain a target language model for processing the task. For example, the original language model is compressed based on the task to obtain a target language model corresponding to the task. Feature(s) of the task may be task-specific parameter(s).

In this embodiment, for a specific task of the original language model, a redundant part of the specific task in the original language model can be considered, and the original language model can be compressed to obtain a target language model that is suitable for the task. The target language model is a small model suitable for the specific task, i.e., different small models are related to different tasks, and are original language models obtained after adjustment. In implementations, when the original language model is a BERT model, BERT compression is performed on different specific tasks in different ways, and a target language model so obtained may be called a compressed BERT model, and its processing object is textual information (a natural language).

Through the above steps S202 to S206 of the present application, an original language model is obtained. A task that needs to be processed by the original language model is determined, and the original language model is converted based on feature(s) of the task to obtain a target language model for processing the task. In other words, this embodiment can automatically compress an original language model into adaptive target language models based on different tasks, which can also be easily implemented when deployed in real-time applications that have strict limitations on computing resources and inference times. This thereby improves the effectiveness of the compression of the original language model on multiple tasks, solves the technical problem of the difficulty of effectively using a model, and achieves a technical effect of an effective use of the model.

The above method of this embodiment will be further introduced hereinafter.

In implementations, at step S206, converting the original language model based on the feature(s) of the task to obtain the target language model for processing the task, includes: inputting the feature(s) of the task into a neural architecture search to obtain a search result; and determining the target language model based on the search result.

In this embodiment, Neural Architecture Search (NAS) is a technology for automatically designing artificial neural networks. In this embodiment, the neural architecture search can be used to search for a corresponding target language model for a specific task. The feature(s) of the task can be inputted into the neural architecture search to obtain a search result, and then the target language model is determined based on the search result, so as to realize the compression of the original language model into a target language model suitable for the specific task, while maintaining good performance. A further description thereof is given as follows.

In implementations, inputting the feature(s) of the task into the neural architecture search to obtain the search result includes: training the original language model as a first language model based on features of tasks; and inputting the first language model to the neural architecture search to obtain a search result.

In this embodiment, the original language model can be initialized when implementing a search for the target language model corresponding to the task based on the neural architecture search. In an initialization step, the original language model is trained as at least one first language model based on features of tasks, i.e., the original language model is fine-tuned and trained as at least one first language model (a fine-tuned BERT models). When the original language model is a BERT model, the first language model can be a fine-tuned BERT model. The first language model is then inputted into the neural architecture search to search for the target language model corresponding to the task, and a search result is obtained. A further description thereof is given as follows.

In implementations, inputting the first language model into the neural architecture search to obtain the search result includes: extracting public knowledge in the original language model as a first knowledge loss; extracting knowledge corresponding to the task as a second knowledge loss of the first language model; and performing a search in the neural architecture search based on the first knowledge loss and the second knowledge loss to obtain the search result.

In this embodiment, when the first language model is inputted into the neural architecture search to obtain the search result, common knowledge can be extracted from the original language model and determined as a first knowledge loss (a knowledge loss value). This embodiment can also determine the knowledge corresponding to the task from the first language model, i.e., determining the task-specific knowledge from the first language model, and set it as a second knowledge loss of the first language model. A search is then performed based on the first knowledge loss and the second knowledge loss in the neural architecture search to obtain the search result. A further description thereof is given as follows.

In implementations, performing the search based on the first knowledge loss and the second knowledge loss in the neural architecture search to obtain the search result includes: determining prompt information based on the first knowledge loss and the second knowledge loss; and searching for a model indicated by the prompt information in an architecture search space corresponding to the network architecture search. Determining the target language model based on the search result includes: determining the model indicated by the prompt information as the target language model.

In this embodiment, when performing the search based on the first knowledge loss and the second knowledge loss in the neural architecture search to obtain the search result, prompt information may be determined based on the first knowledge loss and the second knowledge loss, to effectively find the target language model corresponding to the specific task. In implementations, in an architecture search space, a Differentiable Neural Architecture Search (abbreviated as DNAS) is used to realize an automatic search for a model that is indicated by the prompt information and suitable for the task for the specific task, which is then set as the target language model. The differentiable neural architecture search can support searching in a hierarchical search space, and can realize a differentiable search for the target language model that is suitable for the task.

In implementations, determining the prompt information based on the first knowledge loss and the second knowledge loss includes: establishing cross-task relationships based on the first knowledge loss and the second knowledge loss in a knowledge aggregator, wherein the cross-task relationships are used to indicate relationships between multiple tasks; and determining the prompt information based on the cross-task relationships.

In this embodiment, when the prompt information is determined based on the first knowledge loss and the second knowledge loss, cross-task relationships for multiple tasks may be established in a knowledge aggregator based on the first knowledge loss and the second knowledge loss of the first language model, thereby determining the prompt information based on the cross-task relationships, and using the differentiable neural architecture to search for the target language model indicated by the prompt information for the task. Specifically, by taking the cross-task relationships into account and using the differentiable neural architecture search, this embodiment can compress the original language model into a target language model suitable for the specific task, while maintaining good performance. The knowledge aggregator can speed up the search speed to improve the performance of model compression.

In implementations, this embodiment uses an objective function to perform a search, and the objective function may be obtained by the knowledge aggregator through synthesis of the first knowledge loss and the second knowledge loss.

In implementations, in the knowledge aggregator, establishing the cross-task relationships based on the first knowledge loss and the second knowledge loss includes: recording a first knowledge loss sequence of the original language model and a second knowledge loss sequence of the first language model in the knowledge aggregator, wherein the first knowledge loss sequence includes a knowledge loss of the original language model at at least one moment of training, and the second knowledge loss sequence includes a second knowledge loss of the first language model at at least one moment of training; clustering the multiple tasks based on the first knowledge loss sequence of the original language model and the second knowledge loss sequence of the first language model to obtain at least one meta-task group, wherein the meta-task group includes at least two tasks whose similarity degree is greater than a first threshold; performing normalization based on a target value of the meta-task group to obtain a weight of the meta-task group, wherein the target value is used to indicate an average classification performance of the meta-task group; and establishing the cross-task relationships based on the weight of the meta-task group.

In this embodiment, the knowledge aggregator is a set of schedulers, for example, a dynamical weights scheduler, which can dynamically adjust weights of different losses according to optimization and performance of different tasks. When the cross-task relationships are established based on the first knowledge loss and the second knowledge loss, the knowledge aggregator may record a first knowledge loss sequence of the original language model and a second knowledge loss sequence of each first language model. In implementations, when there are multiple tasks and the corresponding first language model needs to be compressed, searching can be performed for multiple rounds (epochs), and a knowledge loss record point is the end of each round. The knowledge aggregator records a first knowledge loss sequence of the original language model and a second knowledge loss sequence of each first language model. In implementations, as the number of rounds of model training increases, a second knowledge loss sequence of a first language model corresponding to each task can be represented by [L_{Ki}¹, . . . ,L_{Ki}^{t}, . . . ,L_{Ki}^{T}], where L_{Ki}^{t} is used to represent an i-th task, a knowledge loss at the t-th time point of training can be a knowledge loss sequence of length 10.

After recording the first knowledge loss sequence of the original language model and the second knowledge loss sequence of the first language model, clustering can be performed on the multiple tasks based on the first knowledge loss sequence of the original language model and the second knowledge loss sequence of the first language model, i.e., the multiple tasks can be clustered according to a second knowledge loss sequence of a first language model corresponding to each task and the first knowledge loss training of the original language model, and divided into a number of meta-task groups (meta-task). These meta-task groups include at least two tasks whose similarity degree is greater than a first threshold, and tasks with similar optimization trends may be grouped into one meta-task.

Finally, normalization can be performed based on a target value of the meta-task group to obtain a weight of the meta-task group. Normalization can be performed according to an average classification performance of the meta-task group on a verification set, and a normalization coefficient is used as the weight. Specifically, an average classification performance in each group is weighted and normalized as a weight, and then the cross-task relationships are established based on weights of meta-task groups, and the prompt information is determined based on the cross-task relationships, so as to guide the search for the target language model. In implementations, this embodiment can preserve meta-knowledge losses by adjusting the weights of the meta-task groups.

For example, if the original BERT has 3 tasks and corresponding 3 fine-tuned BERTs need to be compressed, 10 rounds of searching can be performed and a knowledge loss record point is the end of each round. The knowledge aggregator then records knowledge loss sequences of length 10 for these 3 fine-tuned BERTs and the original BERT. Meta-task groups are demarcated by clustering. For example, the fine-tuned BERTs corresponding to task 1 and task 2 are demarcated into a group, and the original BERT and the fine-tuned BERT corresponding to task 3 are demarcated into a group. Finally, the average classification performance in each group is weighted and normalized as a weight to guide the search for small models.

It should be noted that using a dynamic weight scheduler to establish the cross-task relationships by the above-mentioned knowledge aggregator of this embodiment is only an exemplary implementation of the embodiments of the present disclosure, and does not mean that the knowledge aggregator of the embodiment of the present disclosure can only use the dynamic weight scheduler to establish the cross-task relationships. Any knowledge aggregator that can establish cross-task relationships based on the first knowledge loss and the second knowledge loss is within the scope of the embodiments of the present disclosure. For example, other technologies such as relational meta-learning, etc., can also be considered to build models of cross-task relationships, which are not further illustrated herein.

In implementations, extracting the common knowledge in the original language model as the first knowledge loss includes: extracting the common knowledge in the original language model as the first knowledge loss in a knowledge decomposer. Extracting the knowledge corresponding to the task in the first language model as the second knowledge loss includes: extracting the knowledge corresponding to the task in the first language model as the second knowledge loss in the knowledge decomposer. The knowledge decomposer is a set of probe classifiers that are trained based on the original language model and the first language model.

In this embodiment, a knowledge decomposer is introduced, which can be used to extract different task knowledge. When extracting common knowledge in an original language model as a first knowledge loss is implemented, the common knowledge in the original language model can be extracted as the first knowledge loss in the knowledge decomposer. When extracting knowledge corresponding to a task in a first language model is extracted as a second knowledge loss is implemented, the knowledge corresponding to the task in the first language model in the knowledge decomposer, for example, knowledge corresponding to each task in each first language model, is extracted as the second knowledge loss. The knowledge decomposer is a set of probe classifiers (probe classifiers) trained on the original language model and each first language model. In implementations, this embodiment determines a vector represented by a first parameter of each inner layer as a set of linear probe classifiers by fixing the original language model and the transformer parameters of each layer of each first language model that is obtained after fine-tuning, After training, this set of probe classifiers can produce classification results (logits) that represent each layer of knowledge.

It should be noted that the use of probe classifiers in the knowledge decomposer of this embodiment is only an exemplary implementation of this embodiment, and does not mean that the knowledge decomposer of the embodiment of the present disclosure is only applicable to probe classifiers. Any method for implementing a knowledge decomposer to extract common knowledge in an original language model as a first knowledge loss, and to extract knowledge corresponding to a task in a first language model as a second knowledge loss is within the scope of this embodiment. Specifically, this embodiment can also use other forms of knowledge decomposer to extract knowledge losses. For example, Flow of Procedure Knowledge and Relational Knowledge can be used to extract knowledge losses, which can be performed in a way similar to the method that uses probe classifiers, which is not further illustrated herein.

In implementations, training the original language model as the at least one first language model based on the features of the tasks includes: adding target task parameters of the tasks to the original language model; and training the target task parameters using a newly added corpus of tasks to obtain the first language model.

In this embodiment, when the original language model is trained as at least one first language model based on task-based features, a small number of target task parameters may be added to an original language model that has been pre-trained for a specific task. The target task parameters are task-specific parameters, and a newly added corpus of tasks is then determined. The newly added target task parameters are retrained on the newly added corpus of tasks, so as to obtain the first language model for processing the task.

In implementations, when the target task parameters are trained on the newly added corpus of tasks, parameters of the original language model remain unchanged, i.e., the parameters of the original language model are frozen.

For example, the original language model of this embodiment is a BERT model. Based on a pre-trained BERT model, a small number of task-specific parameters can be added for a specific downstream task, and parameters of the pre-trained BERT model can be frozen at the same time. The newly added task-specific parameters are retrained on a new corpus of the downstream task, so as to obtain the first language model corresponding to the task.

In implementations, the original language model is obtained by training on data whose data amount is greater than a second threshold, and the number of parameters of the original language model is greater than a third threshold.

In this embodiment, the original language model may be a large model, which is obtained by training data with a data amount greater than a second threshold, where the second threshold is used to measure a critical threshold for a large amount of data used to train the original language model. Specifically, the data used to train the original language model may be a massive amount of data sets. The number of parameters of the original language model in this embodiment is greater than a third threshold, and the third threshold is used to measure a critical threshold for a large number of parameters of the original language model. The threshold can be in the order of billions. It is difficult to deploy such a large model in real-time applications that have strict limitations on computing resources and inference times. However, this embodiment automatically compresses the original language model into adaptive target language models based on different tasks, which can also be easily implemented when deployed in a real-time application that has strict limitations on computing resources and inference times. This thereby can compress a large model with a large number of parameters and slow inference speed into a small model with small number of parameters and a fast inference speed, thus improving the effectiveness of the compression of the original language model on multiple tasks, solving the technical problem of the difficulty of effectively using a model, and achieving a technical effect of effectively using the model.

The embodiments of the present disclosure also provide another model processing method.

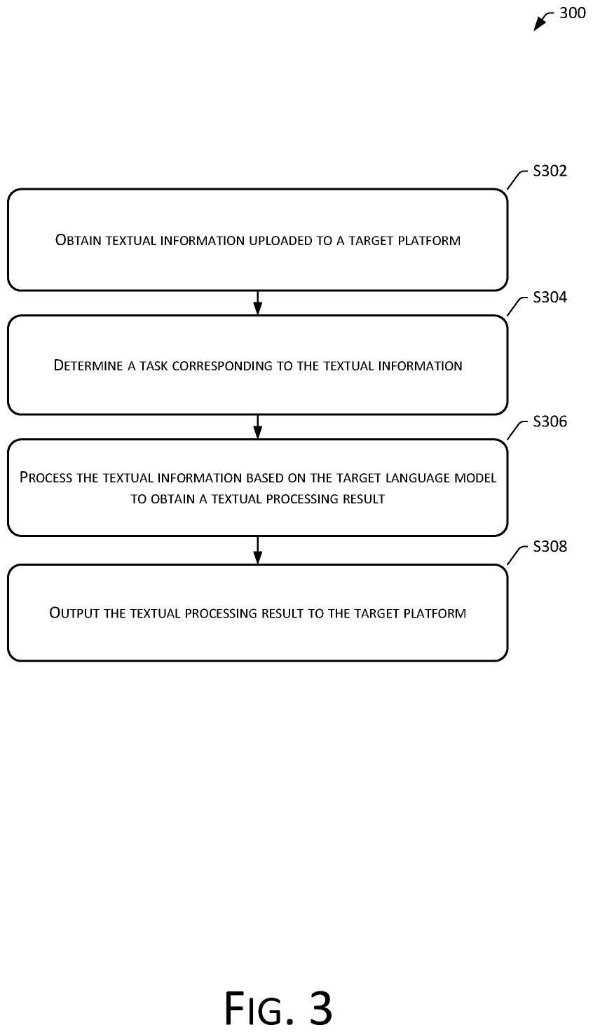

FIG. 3 is a flowchart of another model processing method 300 according to an embodiment of the present disclosure. As shown in FIG. 3, the method 300 may include the following steps:

Step S302: Obtain textual information uploaded to a target platform.

In the technical solutions provided in step S302 of the present disclosure, the target platform may be an artificial intelligence platform (abbreviated as PAI) used in different scenarios. The textual information uploaded to the target platform is language information (a natural language) to be processed, and textual information that is obtained and uploaded to the target platform.

Step S304: Determine a task corresponding to the textual information.

In the technical solutions provided in step S304 of the present disclosure, after obtaining the textual information uploaded to the target platform, a task corresponding to the textual information is determined, wherein the task is processed by an original language model, and a target language model is obtained by converting the original language model based on feature(s) of the task.

At least one task corresponding to the original language model of this embodiment may be a natural language processing task, or may be a different downstream task of the original language model. The original language model can learn a large number of different types of knowledge in a large-scale corpus, and different tasks can use the original language model in different ways. For specific tasks of the original language model, redundant parts of the specific tasks in the original language model can be considered, and the original language model can be compressed to obtain target language models that are suitable for the tasks. The target language model is a small model that is suitable for the specific task, while maintaining good performance.

Step S306: Process the textual information based on the target language model to obtain a textual processing result.

In the technical solutions provided in step S306 of the present disclosure, after the task corresponding to the textual information is determined, the textual information is processed based on the target language model to obtain a textual processing result.

In this embodiment, the task of the original language model has a corresponding target language model. For example, when there are multiple tasks, each task has a corresponding target language model. This embodiment can determine a target language model corresponding to the task, input the obtained language information into the target language model corresponding to the task, and process the language information through the target language model to obtain a textual processing result. In implementations, the target language model of this embodiment may extract key information from the input language information, remove noises, add information, delete information, replace information, etc., which are not specifically limited herein.

Step S308: Output the textual processing result to the target platform.

In the technical solutions provided in step S308 of the present disclosure, after the textual information is processed based on the target language model corresponding to the target task to obtain the textual processing result, the textual processing result can be outputted to the target platform, so that the target platform implements a corresponding service based on textual processing result.

Through the above steps S302 to S308, the present application obtains textual information uploaded to a target platform, determines a target task corresponding to the textual information from at least one task, processes the textual information based on a target language model corresponding to the target task to obtain a textual processing result, and output the textual processing result to the target platform. In other words, this embodiment automatically compresses an original language model into adaptive target language models based on different tasks, and processes textual information uploaded to a target platform, and output a textual processing result so obtained to the target platform. This can also be easily implemented in real-time applications where computing resources and inference times are strictly limited, thereby improving the effectiveness of the compression of the original language model on multiple tasks, solving the technical problem of the difficulty of effectively using a model, and achieving a technical effect of an effective use of the model.

The above method of this embodiment will be further introduced as follows.

In implementations, when the target platform is a transaction platform, the textual information includes: textual transaction information uploaded to the transaction platform.

In this embodiment, the target platform may be a transaction platform, for example, a shopping platform, and the above-mentioned textual information in this embodiment may be textual transaction information uploaded to the transaction platform to meet a user's transaction needs.

In implementations, the textual transaction information includes at least one of the following: textual query information for querying a transaction object; textual information associated with a transaction operation performed by the transaction object; textual evaluation information for evaluating the transaction object; and textual search information for querying an associated object related to the transaction object.

In this embodiment, when the target platform is a transaction platform, the textual transaction information may include textual query information for querying a transaction object, where the transaction object may be a commodity, a virtual item, etc., which is not specifically limited herein. The textual query information may include, but is not limited to, a price of a product that is queried, a performance parameter of the product, an inventory of the product, a purchase amount of the product, evaluation information of the product, etc., which is not specifically limited herein.

In implementations, the textual transaction information of this embodiment may also include textual information associated with a transaction operation performed by a transaction object, where the transaction operation may be an order placing operation, an order deletion operation, a payment operation, a return operation, etc., which is not specifically limited herein.

In implementations, the textual transaction information of this embodiment may also include textual evaluation information for evaluating a transaction object. For example, when a user purchases a transaction object, the textual evaluation information can be used on the transaction platform to achieve the purpose of evaluating the transaction object.

In implementations, the textual transaction information of this embodiment may also include textual search information for querying an associated object related to the transaction object, where the associated object may be a merchant to which the transaction object belongs, or may be other transaction objects of a same type of the transaction object, or may be other merchants of a same nature as that of the merchant to which the transaction object belongs, which is not specifically limited herein.

It should be noted that the above-mentioned target platform in this embodiment being a transaction platform is only an exemplary implementation of the embodiments of the present disclosure, and does not mean that the target platform of the embodiments of the present disclosure is only a transaction platform. Any other artificial intelligence platforms that can be applied in different scenarios are all within the scope of this embodiment, which are not further illustrated herein.

In implementations, the method further includes: inputting feature(s) of the task into a neural architecture search to obtain a search result; and determining the target language model based on the search result.

In this embodiment, Neural Architecture Search is a technology for automatically designing artificial neural networks. In this embodiment, the neural architecture search can be used to search for a corresponding target language model for a task. The feature(s) of the task can be inputted into the neural architecture search to obtain a search result, and then the target language model is determined based on the search result, so as to realize the compression of the original language model into a target language model suitable for the specific task, while maintaining good performance. A further description thereof is given as follows.

In implementations, inputting the feature(s) of the task into the neural architecture search to obtain the search result includes: training the original language model as a first language model based on features of tasks; and inputting the first language model to the neural architecture search to obtain a search result.

In this embodiment, inputting the feature(s) of the task into the neural architecture search to obtain the search result, the original language model can be initialized, and the original language model can be trained as at least one first language model based on the task. The first language model is then inputted into the neural architecture search to obtain the search result. A further description thereof is given as follows.

In implementations, inputting the first language model into the neural architecture search to obtain the search result includes: extracting public knowledge in the original language model as a first knowledge loss; extracting knowledge corresponding to the task as a second knowledge loss of the first language model; and performing a search in the neural architecture search based on the first knowledge loss and the second knowledge loss to obtain the search result.

In this embodiment, common knowledge can be extracted from the original language model and determined as a first knowledge loss. This embodiment can also determine the knowledge corresponding to the task from the first language model, i.e., determining the task-specific knowledge from the first language model, and set it as a second knowledge loss of the first language model. A search is then performed based on the first knowledge loss and the second knowledge loss in the neural architecture search to obtain the search result.

In implementations, training the original language model as the at least one first language model based on the features of the tasks includes: adding target task parameters of the tasks to the original language model; and training the target task parameters using a newly added corpus of tasks to obtain the first language model.

In this embodiment, when the original language model is trained as at least one first language model based on tasks, a small number of target task parameters may be added to an original language model that has been pre-trained for a specific task. The target task parameters are task-specific parameters, and a newly added corpus of tasks is then determined. The newly added target task parameters are retrained on the newly added corpus of tasks, so as to obtain the first language model corresponding to the task.

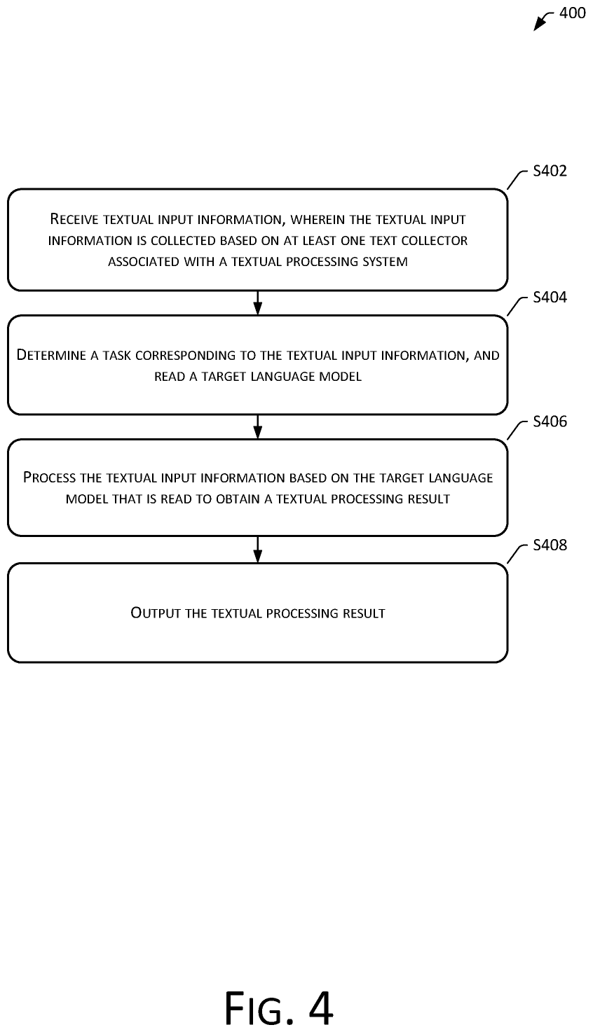

The embodiments of the present disclosure also provide a flowchart of another model processing method. As shown in FIG. 4, the method may include the following steps.

FIG. 4 is a flowchart of another model processing method 400 according to an embodiment of the present disclosure. As shown in FIG. 4, the method 400 may include the following steps:

Step S402: Receive textual input information, wherein the textual input information is collected based on at least one text collector associated with a textual processing system.

In the technical solutions provided in step S402 of the present disclosure, the textual processing system can be any system in a scene where textual processing is required, and is associated with at least one text collector. For example, the text collector can be configured to accurately obtain textual input information in batches according to a user-defined task, or extract content from target text files.

Step S404: Determine a task corresponding to the textual input information, and read a target language model.

In the technical solutions provided in step S404 of the present disclosure, after receiving the textual input information, a task corresponding to the textual input information is determined, and a target language model is read, where the task is processed by an original language model, and the target language model is obtained by converting the original language model based on feature(s) of the task.

In this embodiment, at least one task corresponding to the original language model may be a natural language processing task, or may be a different downstream task of the original language model. The original language model can learn a large number of different types of knowledge in a large-scale corpus, and different tasks can use the original language model in different ways. For specific tasks of the original language model, redundant parts of the specific tasks in the original language model can be considered, and the original language model can be compressed to obtain target language models that are suitable for the tasks. The target language model is a small model that is suitable for the specific task, while maintaining good performance. A target language model corresponding to a specific task is read from target language models corresponding to at least one task.

Step S406: Process the textual input information based on the target language model that is read to obtain a textual processing result.

In the technical solutions provided in step S406 of the present disclosure, after reading a target language model corresponding to a target task, the textual input information can be processed based on the target language model that is read to obtain a textual processing result.

This embodiment can enter input language information that is received into the target language model corresponding to the target task, and process the language information through the target language model to obtain a textual processing result. In implementations, the target language model of this embodiment may extract key information from the input language information, perform denoising, add information, delete information, replace information, etc., which are not specifically limited herein.

Step S408: Output the textual processing result.

In the technical solutions provided in step S408 of the present disclosure, the textual input information is processed based on the target language model that is read to obtain the textual processing result, and then the textual processing result is outputted. For example, a text corresponding to the textual processing result is displayed on a display.

Through the above steps S402 to S408, the present application receives textual input information, where the textual input information is collected based on at least one text collector associated with a textual processing system, determines a target task corresponding to the textual input information from the at least one task, read a target language model corresponding to the target task, process the textual input information based on the target language model that is read to obtain a textual processing result, and output the textual processing result. In other words, this embodiment automatically compresses an original language model into adaptive target language models based on different tasks, processes received textual information, and then outputs an obtained textual processing result, which can also be easily implemented in real-time applications with strict limitations in computing resources and inference times. This improves the effectiveness of the compression of the original language model on multiple tasks, solves the technical problem of the difficulty of effectively using a model, and achieves a technical effect of an effective use of the model.

The above method of this embodiment will be further described as follows.

In implementations, the textual processing system is provided on a robot, where the robot is used for textual interaction.

The method of this embodiment can be applied to a robot, where the textual processing system can be set on the robot. The robot can be a smart speaker to realize textual interaction, and there is no specific limitation herein.

In implementations, the method further includes: inputting feature(s) of the task into a neural architecture search to obtain a search result; and determining the target language model based on the search result.

This embodiment can use the neural architecture search to search for a target language model corresponding to the task, and feature(s) of the task can be inputted into the neural architecture search to obtain a search result. The target language model is then determined based on the search result, to realize compression of the original language model into the target language model that is suitable for the specific task, while still maintaining good performance. A further description is provided below.

In implementations, inputting the feature(s) of the task into the neural architecture search to obtain the search result includes: training the original language model as a first language model based on the feature(s) of the task; inputting the first language model to the neural architecture search to obtain the search result.

In this embodiment, when the feature(s) of the task is/are inputted into the neural architecture search to obtain search result. The original language model can be initialized, and the original language model can be trained as at least one first language model based on the feature(s) of the task. The first language model is then inputted into the neural architecture search to obtain the search result. A further description is provided below.

In implementations, inputting the first language model into the neural architecture search to obtain the search result includes: extracting public knowledge in the original language model as a first knowledge loss; extracting knowledge corresponding to the task as a second knowledge loss of the first language model; and performing a search in the neural architecture search based on the first knowledge loss and the second knowledge loss to obtain the search result.

In this embodiment, common knowledge can be extracted from the original language model and determined as a first knowledge loss. This embodiment can also determine the knowledge corresponding to the task from the first language model, i.e., determining the task-specific knowledge from the first language model, and set it as a second knowledge loss of the first language model. A search is then performed based on the first knowledge loss and the second knowledge loss in the neural architecture search to obtain the search result.

In implementations, training the original language model as the at least one first language model based on the features of the tasks includes: adding target task parameters of the tasks to the original language model; and training the target task parameters using a newly added corpus of tasks to obtain the first language model.

In this embodiment, when the original language model is trained as at least one first language model based on tasks, a small number of target task parameters may be added to an original language model that has been pre-trained for a specific task. The target task parameters are task-specific parameters, and a newly added corpus of tasks is then determined. The newly added target task parameters are retrained on the newly added corpus of tasks, so as to obtain the first language model corresponding to the task.

As an optional example, the model processing method of this embodiment may include: obtaining an original language model in response to a target request sent by a client, wherein the target request includes a task that needs to be processed by the original language model; converting the original language model based on feature(s) of the task to obtain a target language model; and sending the target language model to the client, wherein the target language model is used to process the task on the client.

The model processing method of this embodiment may be executed by a server, reflecting statuses of services on the cloud. In implementations, the server of this embodiment may obtain a target request sent by a client, and the target request is used to request the server to send a corresponding target language model. The target request may carry task(s) that need(s) to be processed by an original language model. The task(s) may be natural language processing task(s). After obtaining the target request, the server responds to the target request sent by the client to obtain the original language model. A processing object of the original language model is textual information (a natural language), which can be a pre-trained context characterization encoder, for example, a BERT Model. The BERT model can be applied to various natural language processing tasks.

After obtaining the original language model, task(s) that need(s) to be processed by the original language model is/are determined. The original language model can learn a large number of different types of knowledge in a large-scale corpus, and different tasks can use the original language model in different ways. After determining the task(s) to be processed by the original language model, the original language model can be converted based on features of the task(s) to obtain a target language model. For example, the original language model is compressed based on the task(s) to obtain target language model(s) corresponding to the task(s). The features of the task(s) may be task-specific parameters. This embodiment is aimed at specific task(s) of the original language model, and redundant parts of the specific task(s) in the original language model can be considered, and the original language model can be compressed to obtain target language model(s) suitable for the task(s). The target language model(s) is/are small model(s) suitable for the specific task(s). Specifically, different small models are related to different tasks, and are adjusted original language models.

After the original language model is converted based on features of the task(s) to obtain the target language model(s), the target language model(s) can be sent to the client, so that the client can use the target language model(s) to process the above task(s) after receiving the target language model(s).

The server of this embodiment can automatically compress an original language model into adaptive target language models based on different tasks, and then send the target language models to a client. The client can use the target language models to process the tasks, which can also be easily implemented in real-time applications where computing resources and inference times are strictly limited, thereby improving the effectiveness of the compression of the original language model on the multiple tasks, solving the technical problem of the difficulty of effectively using a model, and achieving the technical effect of effective uses of the models.

As another optional example, the model processing method of this embodiment may include: obtaining an original language model; determining task(s) that need(s) to be processed by the original language model when the original language model satisfies target condition(s), and converting the original language model based on features of the task(s) to obtain target language model(s) for processing the task(s); and prohibiting the original language model from being converted when the original language model does not satisfy the target condition(s).

In this embodiment, an original language model is obtained. A processing object of the original language model is textual information (a natural language), which can be a pre-trained context characterization encoder, for example, a BERT model, which can determine whether the original language model satisfies certain target condition(s). The target condition(s) can be set based on different scenarios to determine whether the original language model needs to be compressed, so as to improve the efficiency of task processing.

In implementations, if determining that the original language model satisfies the above target condition(s), task(s) that need(s) to be processed by the original language model can be determined. The original language model can learn a large number of different types of knowledge in a large-scale corpus, and different tasks can use the original language model in different ways. After determining the task(s) that need(s) to be processed by the original language model, the original language model can be converted based on features of the task(s) to obtain target language model(s). The features of the task(s) may be task-specific parameters. This embodiment is aimed at specific task(s) of the original language model, and redundant parts of the specific task(s) in the original language model can be considered, and the original language model can be compressed to obtain target language model(s) suitable for the task(s). The target language model(s) is/are small model(s) suitable for the specific task(s). Different small models are related to different tasks, and are adjusted original language models.

In implementations, if determining that the original language model does not satisfy the above-mentioned target condition(s), i.e., determining that it is not necessary to compress the original language model, the original language model may be prohibited from being converted.

In implementations, after obtaining the original language model, the method further includes: determining an amount of training data, where the training data is used for training to obtain the original language model; determining that the original language model satisfies the target condition(s) when the amount of data exceeds a target threshold; and determining that the original language model does not satisfy the target condition(s) when the amount of data does not exceed the target threshold.

In this embodiment, after obtaining the original language model, an amount of training data used for training to obtain the original language model can be determined, and a determination is made as to whether the amount of data is greater than a target threshold. The target threshold can be used to measure whether the data is a critical threshold for a massive amount of data. If a determination is made that the above-mentioned amount of data is greater than the target threshold, this means that the original language model is learned from a massive amount of data sets. In implementations, parameters of the original language model reach the order of one billion. If it is very difficult to deploy the original language model in a real-time application that has strict limitations on computing resources and inference times, this embodiment thereby determines that the original language model satisfies the target condition(s), and compresses the original language model according to the specific task(s) to improve the effectiveness of compression of the original language model on the task(s). If a determination is made that the above amount of data is not greater than the target threshold, this means that the original language model can be deployed in a real-time application that has strict limitations on computing resources and inference times. Therefore, in order to save computing resources, compression may not be performed on the original language model, thereby improving the flexibility of compression processing of the original language model to adapt to different application scenarios.

It should be noted that the method for determining whether to perform compression processing on an original language model in this embodiment is only an exemplary implementation of the embodiments of the present disclosure, and is not limited to the above method for determining whether to perform compression processing on an original language model. Any scenarios that need to determine whether to perform compression processing on an original language model, and corresponding methods are within the scope of this embodiment, and will not be exhaustively illustrated herein.

This embodiment performs compression on an original language model in a scenario where the original language model needs to be compressed, but forbids performing compression on the original language model in a scenario where the original language model does not need to be compressed, thereby realizing on-demand compression to be performed on original language model to adapt to different scenarios. Through the above method, the original language model can be automatically compressed into adaptive target language model(s) based on different tasks, which can also be easily implemented when deployed in real-time applications that have strict limitations on computing resources and inference times. This thereby improves the effectiveness of compression of the original language model on multiple tasks, solves the technical problem of the difficulty of effectively using a model, and achieves a technical effect of an effective use of the model.

As another optional example, the model processing method of this embodiment may include: obtaining an original language model; determining task(s) that need(s) to be processed by the original language model, and sending configuration template(s) associated with features of the task(s) to a client; and obtaining configuration parameter(s) that is/are obtained based on the configuration template(s) from the client, and converting the original language model based on the configuration parameter(s) to obtain target language model(s) for processing the task(s).

In this embodiment, an original language model is obtained, and a processing object of the original language model is textual information (a natural language), which may be a pre-trained context characterization encoder. Task(s) that need(s) to be processed by the original language model is/are determined. The original language model can learn a large number of different types of knowledge in a large-scale corpus, and different tasks can use the original language model in different ways. After determining the task(s) that need(s) to be processed by the original language model, configuration template(s) associated with feature(s) of the task(s) can be sent to a client. The feature(s) of the task(s) can be task-specific parameter(s), and the configuration template(s) can be used by a user to input corresponding configuration parameter(s) on the client to replace parameter(s) that is/are used when the original language model is converted based on the feature(s) of the task(s). For example, the parameter is a loss function used in the conversion of the original language model, which can be a knowledge loss. After the configuration parameter(s) obtained based on the configuration template(s), the original language model can be converted based on the configuration parameter(s) to obtain target language model(s) for processing task(s). The target language model(s) is/are small model(s) suitable for the specific task(s). In other words, different small models are related to different tasks and are adjusted original language models.

In implementations, obtaining the configuration parameter(s) that is/are obtained based on the configuration template(s) from the client includes: obtaining a first knowledge loss, wherein the first knowledge loss is public knowledge extracted by the client from the original language model based on the configuration template(s); obtaining a second knowledge loss, wherein the second knowledge loss is knowledge corresponding to a task extracted by the client from a first language model based on the configuration template(s), and the first language model is obtained by training the original language model based on feature(s) of the task.

In this embodiment, the configuration parameter(s) may be a first knowledge loss, and the first knowledge loss may be common knowledge extracted by the client from the original language model based on the configuration template(s). The configuration parameter(s) in this embodiment may also be a second knowledge loss. The second knowledge loss may be knowledge corresponding to a task determined by the client from a first language model based on the configuration template(s). The first language model is obtained by training the original language model based on feature(s) of the task in an initialization step, and may be obtained by fine-tuning the original language model.

In implementations, converting the original language model based on the configuration parameter(s) to obtain the target language model(s) for processing the task(s) includes: searching based on the first knowledge loss and the second knowledge loss in a neural architecture search to obtain a search result; determining the target language model(s) based on the search result.

In this embodiment, prompt information may be determined based on the first knowledge loss and the second knowledge loss, so as to effectively find a target language model corresponding to a specific task. In implementations, in an architecture search space, a differentiable neural architecture search is used to realize an automatic search for a model suitable for the task indicated by the prompt information for the specific task, and then determine the model as the target language model.

In this embodiment, the configuration template(s) associated with features of the task(s) is/are sent to the client as described above, so that the user can obtain configuration parameter(s) on the client based on the configuration template(s) to replace a related loss function that is used when converting the original language model, thus satisfying the needs of the user, and thereby achieving a technical effect of an effective use of the model.

In related technologies, pre-trained context characterization encoders have been widely used in various natural language processing tasks. Although they are effective, these models are learned from a massive amount of data sets, and their parameters are usually of the order of billions. Deploying such large models in real-time applications that have strict limitations on computing resources and inference times is very difficult. However, this embodiment uses joint effects of modules of a knowledge decomposer, a knowledge aggregator, and a differentiable neural architecture to automatically compress an original language model into adaptive target language models based on different tasks, so that a good balance of efficiency and effectiveness can be achieved in different tasks. It can also be easily implemented when deployed in real-time applications that have strict limitations on computing resources and inference times, so that large models with a large number of parameters and slow inference speeds can be compressed into small models with a small number of parameters and fast inference speeds. This thereby improves the effectiveness of compression of the original language model on multiple tasks, solves the technical problem of the difficulty of effectively using a model, and achieves a technical effect of effectively using the model.

The technical solutions of this embodiment will be introduced with an example in combination with an exemplary embodiment below, and the original language model is specifically described as an example of a BERT model.

When model compression is implemented, the BERT model can be compressed by means of knowledge distillation, pruning, and quantification, etc. However, these methods compress the BERT model into a task-independent structure, i.e., using the same compressed BERT model for all different tasks. The BERT model has learned a lot of different types of knowledge from a large-scale corpus, and different specific downstream tasks use the BERT in different ways. Existing BERT compression methods perform BERT compression on different specific downstream tasks in the same way, but ignore redundant parts of specific tasks in the original BERT model, which makes it difficult to guarantee the effectiveness of BERT compression on multiple tasks.

In order to solve the above, this embodiment proposes a new compression method, which takes into account cross-task relationship sand uses a differentiable neural architecture search to compress a BERT into a small model that is suitable for a specific task while maintaining good performance.

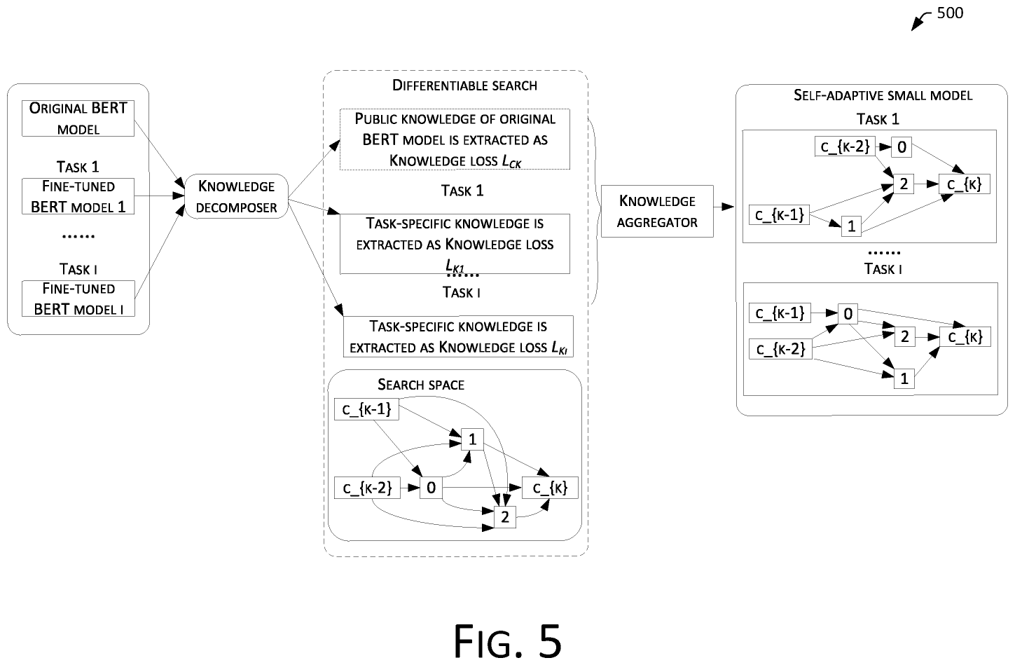

FIG. 5 is a schematic diagram of a BERT model compression 500 according to an embodiment of the present disclosure. As shown in FIG. 5, in this embodiment, for different downstream tasks, in an initialization step, an original BERT model (a Large BERT Model) is fine-tuned and trained into fine-tuned BERT models corresponding to each downstream task (Task), for example, a fine-tuned BERT model corresponding to task 1, . . . , a fine-tuned BERT model i corresponding to task i.

In implementations, based on a pre-trained large BERT model, for a specific downstream task, a small number of task-specific parameters can be added, and parameters of the pre-trained large BERT model can be frozen at the same time. The newly added parameters are retrained on a new corpus of the downstream task to obtain a fine-tuned BERT model corresponding to each downstream task.

This embodiment introduces a knowledge decomposer, which can extract public knowledge in an original BERT model as a knowledge loss LCK, and extract task-specific knowledge in multiple fine-tuned BERT models as knowledge losses {L_{Ki}}. In implementations, the knowledge decomposer of this embodiment is a set of probe classifiers that are trained on the original BERT model and different fine-tuned BERT models.

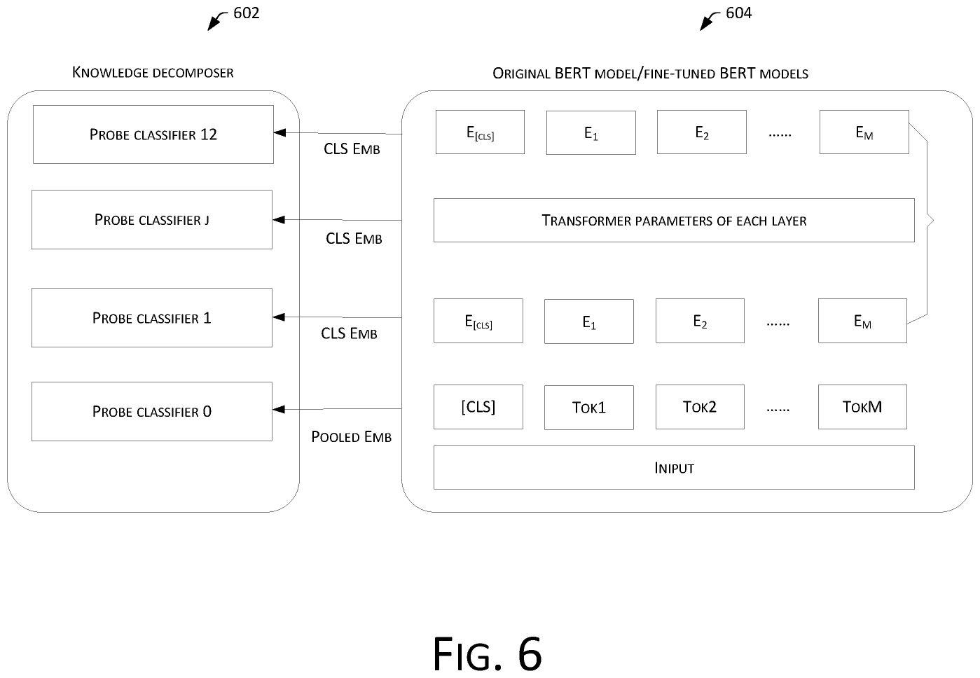

FIG. 6 is a schematic diagram of a knowledge decomposer 602 according to an embodiment of the present disclosure. As shown in FIG. 6, Transformer parameters (E_{[cls}], E₁, E₂ . . . E_{M}) of each layer of a fixed original BERT model and fine-tuned BERT model(s) 604 are determined to be a set of linear probe classifiers (probe classifier 12, probe classifier j, probe classifier 1, probe classifier 0) through a vector represented by the first [CLS] of each internal layer, which respectively correspond to parameters CLS Emb, CLS Emb, CLS Emb, and Pooled. The Pooled parameters correspond to [Parameter CLS], Tok1, Tok2 . . . TokM. After training, this set of probe classifiers can represent classification logits of each layer of knowledge.

This method uses a differentiable neural architecture search to implement an automatic search task for adaptive small models for specific tasks from an architecture search space. Specifically, a search strategy of this embodiment is a differentiable search, and parameters that are involved may be represented by c_{k-1}, c_{k-2}, and c_{k-k}, and relationships among involved 0, 1, and 2 can be indicated by directions of arrows in the search space in FIG. 6.

In implementations, in a search process, a knowledge aggregator is used to establish cross-task relationships based on the knowledge losses La and {L_{Ki}} to provide search prompt information, thereby effectively finding a small model. Specifically, the knowledge aggregator is a group of dynamic weight schedulers, which dynamically adjust weights of different losses according to optimization and performance of different tasks. In implementations, tasks with similar optimization trends in this embodiment will be grouped into a meta-task, and a meta-knowledge loss is preserved by adjusting a weight of a task group.

In implementations, as the number of rounds (epoch) of model training increases, this embodiment records a knowledge loss sequence of each target task as [LKᵢ¹, . . . , LKᵢ^{t},. . . , LKᵢ^{T}], where LKᵢ^{t} represents a knowledge loss of training for an i-th task at a t-th time point. Next, according to the knowledge loss sequence of each task, tasks with similar optimization trends are clustered and demarcated into a number of meta-task groups. Finally, normalization is performed according to average classification performances of the meta-task groups on a verification set, and normalization coefficients are used as weights.

For example, if there are 3 tasks and corresponding 3 fine-tuned BERT models need to be compressed, with 10 rounds of searching and a knowledge loss record point being the end of each round, the knowledge aggregator module then records knowledge loss sequences of length as 10 for these 3 fine-tuned BERT models and an original BERT model. Meta-task groups can be demarcated through clustering. For example, fine-tuned BERT models for tasks 1 and 2 are demarcated into one group, and the original BERT model and a fine-tuned BERT model of task 3 are demarcated into one group. Finally, average classification performances of each group are weighted and normalized as weights to guide a search for small models. Finally adaptive small models that are found and correspond to the tasks are outputted. c_{k-1}, c_{k-2} and c_{k-k} of each adaptive small model, and relationships among 0, 1, and 2 that are involved can be indicated by the directions of the arrows in the adaptive small models in FIG. 6.

This embodiment utilizes joint effects of modules of a knowledge decomposer, a knowledge aggregator, and a differentiable neural architecture to enable the proposed compression method to be used in different downstream tasks, thereby achieving a good balance of efficiency and effectiveness.

It should be noted that, in addition to using a set of probe classifiers to extract knowledge loss, the knowledge decomposer of this embodiment can also use other forms to extract knowledge losses, such as using a procedure of program knowledge and relational knowledge to extract knowledge losses, which can be done in a similar way to probe classifiers.

It should be noted that, in addition to a dynamic weight scheduler, the knowledge aggregator of this embodiment may also consider other technologies such as relational meta-learning to establish a model of cross-task relationships.

Compared with existing methods of compressing an original BERT model into a task-independent structure, this embodiment is a method of automatically compressing a multi-task BERT into an adaptive small model through a neural architecture search. The knowledge decomposer and the knowledge aggregator of this embodiment consider cross-task relationships and group similar tasks according to their optimization trends. This embodiment also combines meta-knowledge of different tasks, improves the search efficiency, improves the effectiveness of compressing BERT on multiple tasks, thereby solving the technical problem of the difficulty of effectively using a model.

It should be noted that the foregoing method embodiments are all expressed as a series of action combinations for the sake of simple description. However, one skilled in the art should know that the present disclosure is not limited by the described orders of actions. Since some steps can be performed in other orders or in parallel according to the present disclosure. Moreover, one skilled in the art should also know that the embodiments described in the specification are all exemplary embodiments, and actions and modules that are involved may not be necessarily required by the present disclosure.

Through the description of the above embodiments, one skilled in the art can clearly understand that the methods according to the above embodiments can be implemented by means of software plus a necessary general hardware platform, and apparently can also be implemented by hardware. However, in many cases, the former one is a better implementation. Based on such understanding, the essence of the technical solutions of the present disclosure or the parts that contribute to the existing technologies can be embodied in a form of a software product. Such computer software product is stored in a storage medium (such as a ROM/RAM, a magnetic disk, an optical disk) that includes a number of instructions to enable a terminal device (which can be a mobile phone, a computer, a server, or a network device, etc.) to execute the methods described in each embodiment of the present disclosure.

According to the embodiments of the present disclosure, a model processing apparatus for implementing the above model processing method as shown in FIG. 2 is also provided.

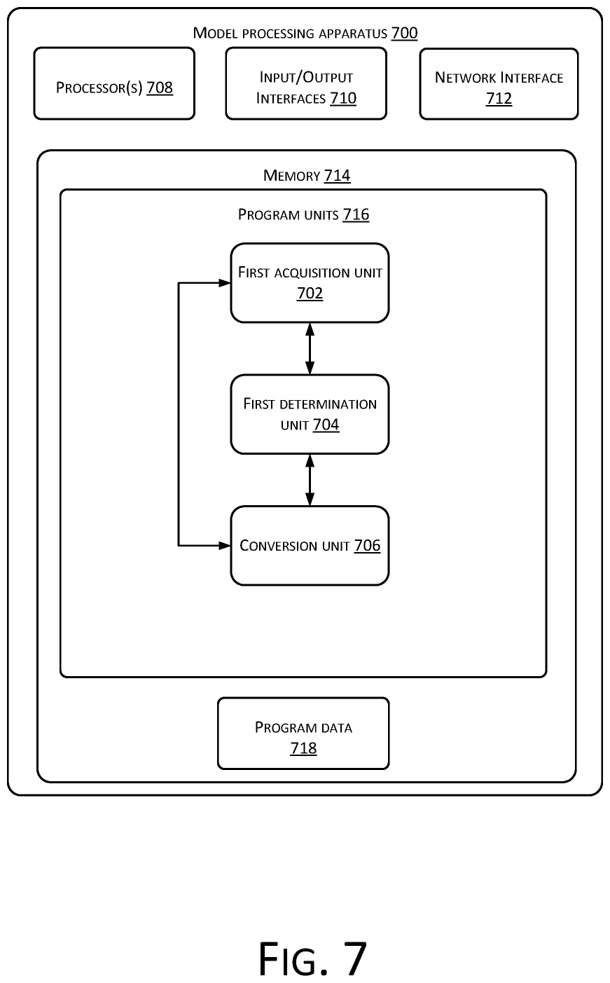

FIG. 7 is a schematic diagram of a model processing apparatus 700 according to an embodiment of the present disclosure. As shown in FIG. 7, the model processing apparatus 700 may include: a first acquisition unit 702, a first determination unit 704 and a conversion unit 706.

The first acquisition unit 702 is configured to obtain an original language model.

The first determination unit 704 is configured to determine task(s) that need(s) to be processed by the original language model.

The conversion unit 706 is configured to convert the original language model based on features of the task(s) to obtain a target language model for processing the task(s).

In implementations, the model processing apparatus 700 may further include one or more processors 708, an input/output (I/O) interface 710, a network interface 712, and memory 714.

The memory 714 may include a form of computer readable media such as a volatile memory, a random access memory (RAM) and/or a non-volatile memory, for example, a read-only memory (ROM) or a flash RAM. The memory 714 is an example of a computer readable media. In implementations, the memory 714 may include program units 716 and program data 718. The program units 716 may include one or more units as described in the foregoing description and FIG. 7.

In implementations, the computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

It should be noted here that the first acquisition unit 702, the first determination unit 704, and the conversion unit 706 correspond to steps S202 to S206 in the foregoing embodiments. Examples and application scenarios implemented by these three units are the same as those of the corresponding steps, but are not limited to the content disclosed in the foregoing embodiments. It should be noted that the above-mentioned modules, which act as a part of the apparatus, can run in the computer terminal 100 provided in the foregoing embodiments.

The embodiments of the present disclosure also provide a model processing apparatus for implementing the above model processing method as shown in FIG. 3.

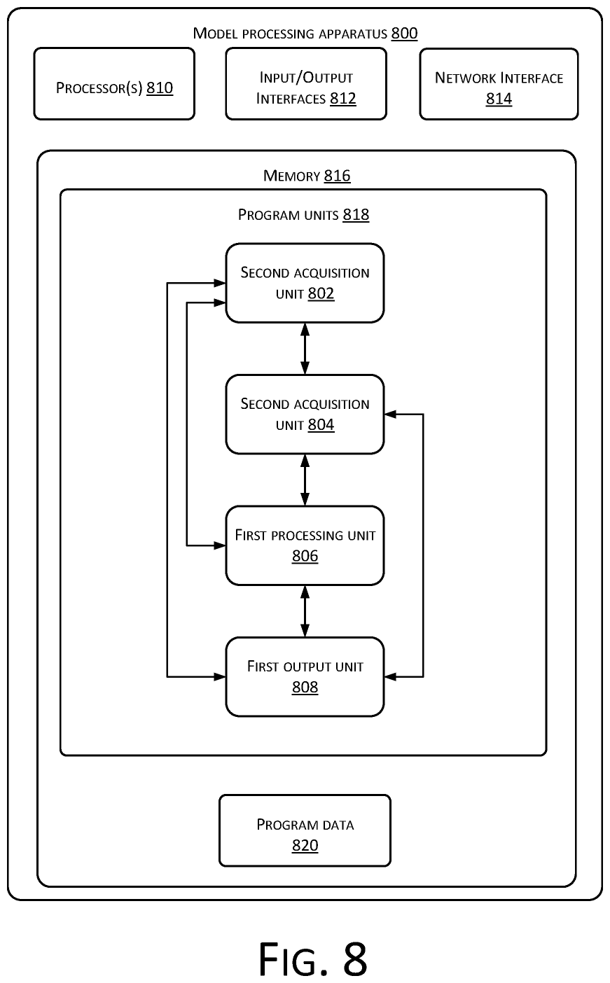

FIG. 8 is a schematic diagram of another model processing apparatus 800 according to an embodiment of the present disclosure. As shown in FIG. 8, the model processing apparatus 800 may include: a second acquisition unit 802, a second determination unit 804, a first processing unit 806, and a first output unit 808.

The second obtaining unit 802 is configured to obtain textual information that is uploaded to a target platform.

The second determination unit 804 is configured to determine a task corresponding to the textual information, where the task is processed by an original language model, and the target language model is obtained by converting the original language model based on features of the task.

The first processing unit 806 is configured to process the textual input information based on the target language model to obtain a textual processing result.

The first output unit 808 is used to output the textual processing result to the target platform.

In implementations, the model processing apparatus 800 may further include one or more processors 810, an input/output (I/O) interface 812, a network interface 814, and memory 816.

The memory 816 may include a form of computer readable media, and is an example of a computer readable media as described in the foregoing description. In implementations, the memory 816 may include program units 818 and program data 820. The program units 818 may include one or more units as described in the foregoing description and FIG. 8.

It should be noted here that the second acquisition unit 802, the second determination unit 804, the first processing unit 806, and the first output unit 808 correspond to steps S302 to S308 in the foregoing embodiments. Examples and application scenarios implemented by these four units are the same as those of the corresponding steps, but are not limited to the content disclosed in the foregoing embodiments. It should be noted that the above-mentioned modules, which act as a part of the apparatus, can run in the computer terminal 100 provided in the foregoing embodiments.

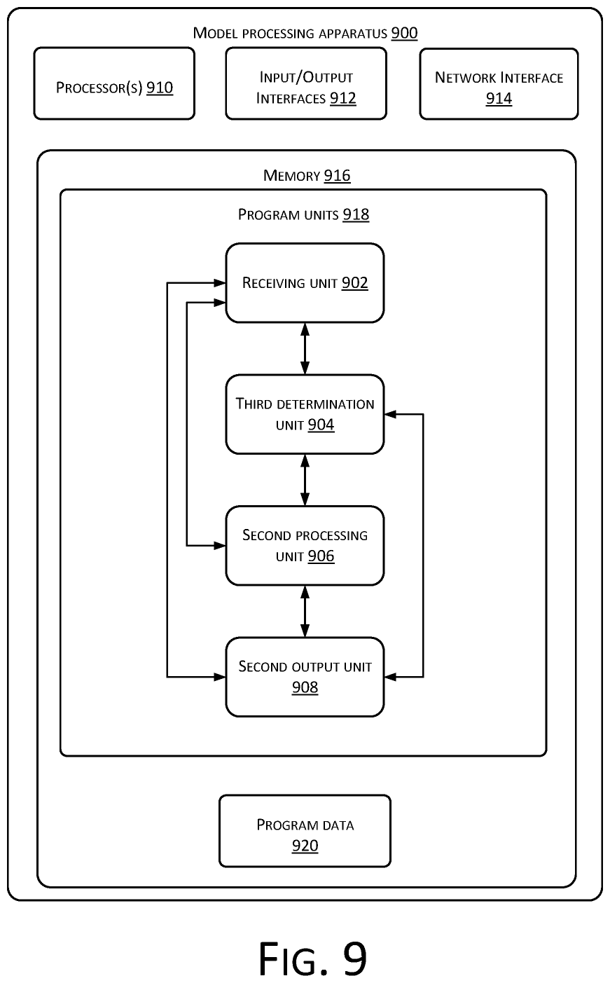

FIG. 9 is a schematic diagram of another model processing apparatus 900 according to an embodiment of the present disclosure. As shown in FIG. 9, the model processing apparatus 900 may include: a receiving unit 902, a third determination unit 904, a second processing unit 906 and a second output unit 908.

The receiving unit 902 is configured to receive textual input information, wherein the textual input information is collected based on at least one text collector associated with a textual processing system.

The third determination unit 904 is configured to determine a task corresponding to the textual input information and read a target language model, where the task is processed by an original language model, and the target language model is obtained by converting the original language model based on features of the task.

The second processing unit 906 is configured to process the textual input information based on the target language model that is read to obtain a textual processing result.

The second output unit 908 is configured to output the textual processing result.

In implementations, the model processing apparatus 900 may further include one or more processors 910, an input/output (I/O) interface 912, a network interface 914, and memory 916.

The memory 916 may include a form of computer readable media, and is an example of a computer readable media as described in the foregoing description. In implementations, the memory 916 may include program units 918 and program data 920. The program units 918 may include one or more units as described in the foregoing description and FIG. 9.

It should be noted here that the receiving unit 902, the third determination unit 904, the second processing unit 906, and the second output unit 908 correspond to steps S402 to S408 in the foregoing embodiments. Examples and application scenarios implemented by these four units are the same as those of the corresponding steps, but are not limited to the content disclosed in the foregoing embodiments. It should be noted that the above-mentioned modules, which act as a part of the apparatus, can run in the computer terminal 100 provided in the foregoing embodiments.

The model processing apparatuses of this embodiment automatically compress an original language model into adaptive target language models based on different tasks, which can also be easily implemented when deployed in real-time applications that have strict limitations on computing resources and inference times. Thereby, the effectiveness of the compression of an original language model on multiple tasks is improved, the technical problem of the difficulty of effectively using a model, and a technical effect of an effective use of the model is achieved.

The embodiments of the present disclosure may provide a computer terminal. The computer terminal may be any computer terminal device in a group of computer terminals. In implementations, the computer terminal may also be replaced with a terminal device such as a mobile terminal.

In implementations, the computer terminal may be located in at least one network device among multiple network devices in a computer network.

In this embodiment, the computer terminal can execute program codes of the following steps in a model processing method of an application program: obtaining an original language model; determining a task that needs to be processed by the original language model; and converting the original language model based on features of the task to obtain a target language model for processing the task.

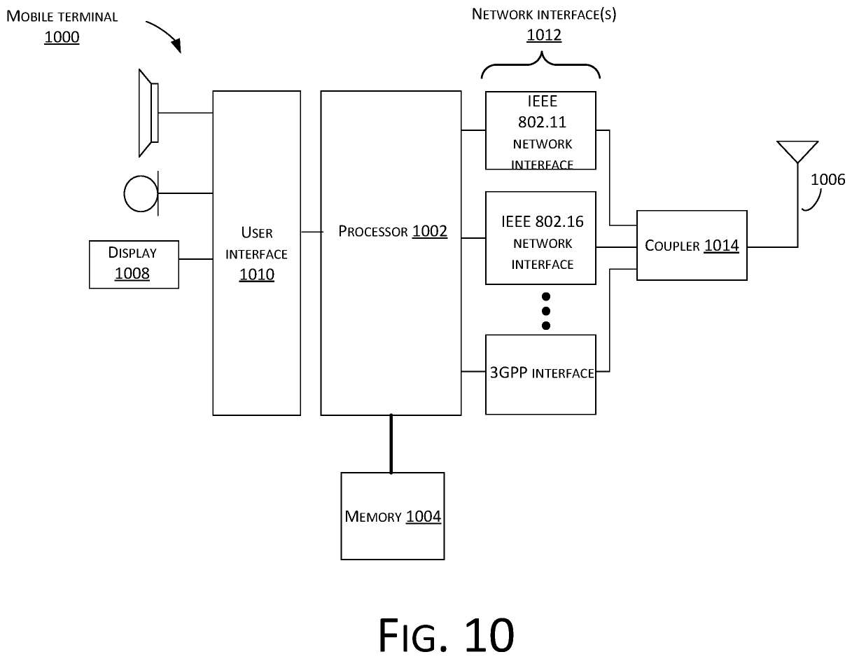

In implementations, FIG. 10 is a structural block diagram of a mobile terminal 1000 according to an embodiment of the present disclosure. As shown in FIG. 10, the mobile terminal 1000 may include: one or more (only one is shown in the figure) processors 1002, a memory 1004, and a transmission device 1006. In implementations, the mobile terminal 1000 may further include a display 1008, a user interface 1010, one or more network interfaces 1012, and a coupler 1014 that connects the one or more network interfaces 1012 with the transmission device 1006.

The memory can be used to store software programs and modules, such as program instructions/modules corresponding to the model processing methods and apparatuses in the embodiments of the present disclosure. The processor executes various functional applications and data processing by running software programs and modules stored in the memory, i.e., to implement the above-mentioned model processing methods. The memory may include a high-speed random access memory, and may also include a non-volatile memory, such as one or more magnetic storage devices, flash memory, or other non-volatile solid-state memory. In some examples, the memory may further include a storage device remotely deployed with respect to the processor, and such remote storage device may be connected to the mobile terminal A through a network. Examples of the network include, but are not limited to, the Internet, a corporate intranet, a local area network, a mobile communication network, and a combination thereof.

The processor can call information and an application program stored in the memory through the transmission device to perform the following steps: obtaining an original language model; determining the task that needs to be processed by the original language model; and converting the original language model based on features of the task to obtain a target language model that is used for processing the task.

In implementations, the processor may also execute program codes of the following steps: inputting features of the task into a neural architecture search to obtain a search result; and determining the target language model based on the search result.

In implementations, the processor may also execute program codes of the following steps: training the original language model as a first language model based on the features of the task; inputting the first language model into a neural architecture search to obtain a search result.

In implementations, the processor may also execute program codes of the following steps: extracting common knowledge in the original language model as a first knowledge loss; extracting knowledge corresponding to the task in the first language model as a second knowledge loss of the first language model; and performing a search in the neural architecture search based on the first knowledge loss and the second knowledge loss, and obtaining the search result.

In implementations, the processor may also execute program codes of the following steps: determining prompt information based on the first knowledge loss and the second knowledge loss; searching for a model indicated by the prompt information in an architecture search space corresponding to the neural architecture search; and determining the model indicated by the prompt information as the target language model.

In implementations, the processor may also execute program codes of the following steps: establishing cross-task relationships based on the first knowledge loss and the second knowledge loss in a knowledge aggregator, wherein the cross-task relationships are used to indicate relationships among multiple tasks; and determining the prompt information based on the cross-task relationships.

In implementations, the processor may also execute program codes of the following steps: recording a first knowledge loss sequence of the original language model and a second knowledge loss sequence of the first language model in the knowledge aggregator, wherein the first knowledge loss sequence includes a knowledge loss of the original language model at at least one moment of training, the second knowledge loss sequence includes a second knowledge loss of the first language model at at least one moment of training; clustering multiple tasks to obtain at least one meta-task group based on the first knowledge loss sequence of the original language model and the second knowledge loss sequence of the first language model, wherein the meta-task group includes at least two tasks whose similarity degree is greater than a first threshold; performing normalization based on a target value of the meta-task group to obtain a weight of the meta-task group, wherein the target value is used to indicate an average classification performance of the meta-task group; and establishing the cross-task relationships based on the weight of the meta-task group.

In implementations, the processor may also execute program codes of the following steps: extracting the common knowledge in the original language model as the first knowledge loss in a knowledge decomposer, extracting the knowledge corresponding to the task in the first language model as the second knowledge loss including extracting the knowledge corresponding to the task in the first language model as the second knowledge loss in the knowledge decomposer.

In implementations, the processor may also execute program codes of the following steps: adding target task parameters of the task to the original language model; and training the target task parameters on a newly added corpus of the task to obtain the first language model.

In implementations, the processor may call information and application programs stored in the memory through the transmission device to perform the following steps: obtaining textual information uploaded to a target platform; determining a task corresponding to the textual information, wherein the task is processed by an original language model, and a target language model is obtained by converting the original language model based on features of the task; processing the textual information based on the target language model to obtain a textual processing result; and outputting the textual processing result to the target platform.

In implementations, the processor may also execute program codes of the following steps: inputting features of the task into a neural architecture search to obtain a search result; and determining the target language model based on the search result.

In implementations, the processor may also execute program codes of the following steps: training the original language model as a first language model based on the features of the task; and inputting the first language model into the neural architecture search to obtain the search result.

In implementations, the processor may also execute program codes of the following steps: extracting common knowledge in the original language model as a first knowledge loss; extracting knowledge corresponding to the task in the first language model as a second knowledge loss of the first language model; and performing a search in the neural architecture search based on the first knowledge loss and the second knowledge loss to obtain the search result.

In implementations, the processor may also execute program codes of the following steps: adding target task parameters of the task to the original language model; and training the target task parameters on a newly added corpus of the task to obtain the first language model.

In implementations, the processor may call information and application programs stored in the memory through the transmission device to perform the following steps: receiving textual input information, wherein the textual input information is collected based on at least one text collector associated with a textual processing system; determining a task corresponding to the textual input information, and reading a target language model, wherein the task is processed by an original language model, and the target language model is obtained by converting the original language model based on features of the task; processing the textual input information based on the target language model that is read to obtain a textual processing result; and outputting the textual processing result.

In implementations, the processor may also execute program codes of the following steps: inputting features of the task into a neural architecture search to obtain a search result; and determining the target language model based on the search result.

In implementations, the processor may also execute program codes of the following steps: training the original language model as a first language model based on the features of the task; and inputting the first language model into the neural architecture search to obtain the search result.

In implementations, the processor may also execute program codes of the following steps: extracting common knowledge in the original language model as a first knowledge loss; extracting knowledge corresponding to the task in the first language model as a second knowledge loss of the first language model; and performing a search in the neural architecture search based on the first knowledge loss and the second knowledge loss to obtain the search result.

In implementations, the processor may also execute program codes of the following steps: adding target task parameters of the task to the original language model; and training the target task parameters on a newly added corpus of the task to obtain the first language model.

In implementations, the processor may call information and application programs stored in the memory through the transmission device to perform the following steps: obtaining an original language model responsive to a target request sent by a client, wherein the target request includes a task that needs to be processed by the original language model; converting the original language model based on features of the task to obtain a target language model; and sending the target language model to the client, wherein the target language model is used to process the task on the client.

In implementations, the processor may call information and application programs stored in the memory through the transmission device to perform the following steps: obtaining an original language model; determining a task that needs to be processed by the original language when the original language model satisfies a target condition, and converting the original language model based on features of the task to obtain a target language model for processing the task; and prohibiting the original language model from being converted when the original language model does not satisfy the target condition.

In implementations, the processor may also execute program codes of the following steps: determining an amount of training data after obtaining the original language model, wherein the training data is used for training to obtain the original language model; determining that the original language model satisfies the target condition when the amount of data exceeds a target threshold; and determining that the original language model does not satisfy the target condition when the amount of data does not exceed the target threshold.

In implementations, the processor may call information and application programs stored in the memory through the transmission device to perform the following steps: obtaining an original language model; determining a task that needs to be processed by the original language model, and sending a configuration template associated with features of the task to a client; obtaining configuration parameters that are obtained by the client based on the configuration template, and converting the original language model based on the configuration parameters to obtain a target language model for processing the task.

In implementations, the processor may also execute program codes of the following steps: obtaining a first knowledge loss, wherein the first knowledge loss is common knowledge extracted by the client from the original language model based on the configuration template; and obtaining a second knowledge loss, wherein the second knowledge loss is knowledge corresponding to the task extracted from a first language model by the client based on the configuration template, and the first language model is obtained by training the original language model based on the features of the task.

In implementations, the processor may also execute program codes of the following steps: performing a search in a neural architecture search based on the first knowledge loss and the second knowledge loss to obtain a search result; and determining the target language model based on the search result.

By using the embodiments of the present disclosure, model processing methods are provided. An original language model is obtained, and a task that needs to be processed by the original language model is determined. The original language model is converted based on features of the task to obtain a target language model for processing the task. In other words, the present application automatically compresses an original language model into adaptive target language models based on different tasks, which can also be easily implemented when deployed in real-time applications that have strict limitations on computing resources and inference times, thereby improving the effectiveness of compression of the original language model on multiple tasks, solving the technical problem of the difficulty of effectively using a model, and achieving a technical effect of an effective use of the model.

One of ordinary skill in the art can understand that the structure shown in FIG. 10 is only illustrative, and the mobile terminal A can also be a terminal device, such as a smart phone (such as an Android phone, an iOS phone, etc.), a tablet computer, a handheld computer, and a mobile Internet device (MID), a PAD, etc. FIG. 10 does not limit the structure of the above-mentioned mobile terminal A. For example, the mobile terminal A may also include more or fewer components (such as a network interface, a display device, etc.) than those shown in FIG. 10, or have a configuration different from that shown in FIG. 10.

One of ordinary skill in the art can understand that all or part of the steps in the various methods of the above-mentioned embodiments can be completed by instructing relevant hardware of a terminal device through a program. The program can be stored in a computer-readable storage medium, which may include: a flash memory, a read-only memory (ROM), a random access memory (RAM), a magnetic disk, or an optical disk, etc.

The embodiments of the present disclosure also provide a storage medium. In implementations, the storage medium may be used to store program codes executed by the model processing method provided in the foregoing embodiments.

In implementations, the storage medium may be located in any computer terminal in a group of computer terminals in a computer network, or located in any mobile terminal in a group of mobile terminals.

In implementations, the storage medium is configured to store program codes for performing the following steps: obtaining an original language model; determining a task that needs to be processed by the original language model; and converting the original language model based on features of the task to obtain the target language model used for processing the task.

In implementations, the storage medium is further configured to store program codes for performing the following steps: inputting features of the task into a neural architecture search to obtain a search result; and determining the target language model based on the search result.

In implementations, the storage medium is further configured to store program codes for performing the following steps: training the original language model as a first language model based on the features of the task; inputting the first language model into a neural architecture search to obtain a search result.

In implementations, the storage medium is also configured to store program codes for performing the following steps: extracting common knowledge in the original language model as a first knowledge loss; extracting knowledge corresponding to the task in the first language model as a second knowledge loss of the first language model; and performing a search in the neural architecture search based on the first knowledge loss and the second knowledge loss, and obtaining the search result.

In implementations, the storage medium is further configured to store program codes for performing the following steps: determining prompt information based on the first knowledge loss and the second knowledge loss; searching for a model indicated by the prompt information in an architecture search space corresponding to the neural architecture search; and determining the model indicated by the prompt information as the target language model.

In implementations, the storage medium is further configured to store program codes for performing the following steps: establishing cross-task relationships based on the first knowledge loss and the second knowledge loss in a knowledge aggregator, wherein the cross-task relationships are used to indicate relationships among multiple tasks; and determining the prompt information based on the cross-task relationships.

In implementations, the storage medium is further configured to store program codes for performing the following steps: recording a first knowledge loss sequence of the original language model and a second knowledge loss sequence of the first language model in the knowledge aggregator, wherein the first knowledge loss sequence includes a knowledge loss of the original language model at at least one moment of training, the second knowledge loss sequence includes a second knowledge loss of the first language model at at least one moment of training; clustering multiple tasks to obtain at least one meta-task group based on the first knowledge loss sequence of the original language model and the second knowledge loss sequence of the first language model, wherein the meta-task group includes at least two tasks whose similarity degree is greater than a first threshold; performing normalization based on a target value of the meta-task group to obtain a weight of the meta-task group, wherein the target value is used to indicate an average classification performance of the meta-task group; and establishing the cross-task relationships based on the weight of the meta-task group.

In implementations, the storage medium is also configured to store program codes for performing the following steps: extracting the common knowledge in the original language model as the first knowledge loss in a knowledge decomposer, extracting the knowledge corresponding to the task in the first language model as the second knowledge loss including extracting the knowledge corresponding to the task in the first language model as the second knowledge loss in the knowledge decomposer.

In implementations, the storage medium is also configured to store program codes for performing the following steps: adding target task parameters of the task to the original language model; and training the target task parameters on a newly added corpus of the task to obtain the first language model.

In implementations, the storage medium is configured to store program codes for performing the following steps: obtaining textual information uploaded to a target platform; determining a task corresponding to the textual information, wherein the task is processed by an original language model, and a target language model is obtained by converting the original language model based on features of the task; processing the textual information based on the target language model to obtain a textual processing result; and outputting the textual processing result to the target platform.

In implementations, the storage medium is further configured to store program codes for performing the following steps: inputting features of the task into a neural architecture search to obtain a search result; and determining the target language model based on the search result.

In implementations, the storage medium is further configured to store program codes for performing the following steps: training the original language model as a first language model based on the features of the task; and inputting the first language model into the neural architecture search to obtain the search result.

In implementations, the storage medium is also configured to store program codes for performing the following steps: extracting common knowledge in the original language model as a first knowledge loss; extracting knowledge corresponding to the task in the first language model as a second knowledge loss of the first language model; and performing a search in the neural architecture search based on the first knowledge loss and the second knowledge loss to obtain the search result.

In implementations, the storage medium is also configured to store program codes for performing the following steps: adding target task parameters of the task to the original language model; and training the target task parameters on a newly added corpus of the task to obtain the first language model.

In implementations, the storage medium is configured to store the program codes for performing the following steps: receiving textual input information, wherein the textual input information is collected based on at least one text collector associated with a textual processing system; determining a task corresponding to the textual input information, and reading a target language model, wherein the task is processed by an original language model, and the target language model is obtained by converting the original language model based on features of the task; processing the textual input information based on the target language model that is read to obtain a textual processing result; and outputting the textual processing result.

In implementations, the storage medium is further configured to stores program code for performing the following steps: inputting features of the task into a neural architecture search to obtain a search result; and determining the target language model based on the search result.

In implementations, the storage medium is further configured to store program codes for performing the following steps: training the original language model as a first language model based on the features of the task; and inputting the first language model into the neural architecture search to obtain the search result.

In implementations, the storage medium is also configured to store program codes for performing the following steps: extracting common knowledge in the original language model as the first knowledge loss; extracting common knowledge in the original language model as a first knowledge loss; extracting knowledge corresponding to the task in the first language model as a second knowledge loss of the first language model; and performing a search in the neural architecture search based on the first knowledge loss and the second knowledge loss to obtain the search result.

In implementations, the storage medium is also configured to store program codes for performing the following steps: adding target task parameters of the task to the original language model; and training the target task parameters on a newly added corpus of the task to obtain the first language model.

In implementations, the storage medium is configured to store program codes for performing the following steps: obtaining an original language model responsive to a target request sent by a client, wherein the target request includes a task that needs to be processed by the original language model; converting the original language model based on features of the task to obtain a target language model; and sending the target language model to the client, wherein the target language model is used to process the task on the client.

In implementations, the storage medium is configured to store program codes used to perform the following steps: obtaining an original language model; determining a task that needs to be processed by the original language when the original language model satisfies a target condition, and converting the original language model based on features of the task to obtain a target language model for processing the task; and prohibiting the original language model from being converted when the original language model does not satisfy the target condition.

In implementations, the storage medium is also configured to store program codes for performing the following steps: determining an amount of training data after obtaining the original language model, wherein the training data is used for training to obtain the original language model; determining that the original language model satisfies the target condition when the amount of data exceeds a target threshold; and determining that the original language model does not satisfy the target condition when the amount of data does not exceed the target threshold.

In implementations, the storage medium is configured to store program codes used to perform the following steps: obtaining an original language model; determining a task that needs to be processed by the original language model, and sending a configuration template associated with features of the task to a client; obtaining configuration parameters that are obtained by the client based on the configuration template, and converting the original language model based on the configuration parameters to obtain a target language model for processing the task.

In implementations, the storage medium is further configured to store program codes for performing the following steps: obtaining a first knowledge loss, wherein the first knowledge loss is common knowledge extracted by the client from the original language model based on the configuration template; and obtaining a second knowledge loss, wherein the second knowledge loss is knowledge corresponding to the task extracted from a first language model by the client based on the configuration template, and the first language model is obtained by training the original language model based on the features of the task.

In implementations, the storage medium is further configured to store program codes for performing the following steps: performing a search in a neural architecture search based on the first knowledge loss and the second knowledge loss to obtain a search result; and determining the target language model based on the search result.

Sequence numbers of the foregoing embodiments of the present disclosure are only used for description, and do not represent advantages and disadvantages of the embodiments.

In the foregoing embodiments of the present disclosure, a description of each embodiment has its own focus. For parts that are not described in detail in an embodiment, reference may be made to related descriptions of other embodiments.

In the embodiments provided in the present application, it should be understood that the disclosed technical content can be implemented in other ways. The apparatus embodiments described above are merely illustrative. For example, a division of units is only a division of logical functions. In practical implementations, other methods of division may exist. For example, multiple units or components may be combined or may be integrated into another system, or some features may be ignored or not be implemented. In addition, displayed or discussed mutual coupling or direct coupling or communication connection may be indirect coupling or communication connection through some interfaces, units or modules, and may be in electrical or other forms.

The units described as separate components may or may not be physically separated. The components displayed as units may or may not be physical units, i.e., may be located in a single place, or may be distributed on multiple network units. Some or all of the units may be selected according to actual needs to achieve the objectives of the solutions of the embodiments.

In addition, the functional units in various embodiments of the present disclosure may be integrated into a single processing unit. Alternatively, each unit may exist to be physically independent. Alternatively, two or more units may be integrated into a single unit. The above-mentioned integrated unit can be implemented in a form of hardware or software functional unit.

If being implemented in a form of a software functional unit and sold or used as an independent product, the integrated unit can be stored in a computer readable storage medium. Based on such understanding, the essence of the technical solutions of the present disclosure, the parts that contribute to the existing technologies, or all or part of the technical solutions can be embodied in a form of a software product. Such computer software product is stored in a storage medium, which includes a number of instructions to make a computer device (which may be a personal computer, a server, or a network device, etc.) to execute all or part of the steps of the methods described in each embodiment of the present disclosure. The storage media include various types of media that are capable to store program codes, such as a U disk, a read-only memory (ROM), a random access memory (RAM), a portable hard disk, a magnetic disk, or an optical disk, etc.

The above are only exemplary embodiments of the present disclosure. It should be pointed out that one of ordinary skill in the art can make a number of improvements and modifications, without departing from the principles of the present disclosure. These improvements and modifications should also fall in the scope of protection of the present disclosure.

The present disclosure can be further understood using the following clauses.

Clause 1: A model processing method comprising: obtaining an original language model; determining a task that needs to be processed by the original language model; and converting the original language model based on features of the task to obtain the target language model used for processing the task.

Clause 2: The method of Clause 1, wherein converting the original language model based on the features of the task to obtain the target language model used for processing the task comprises: inputting features of the task into a neural architecture search to obtain a search result; and determining the target language model based on the search result.

Clause 3: The method of Clause 2, wherein inputting the features of the task into the neural architecture search to obtain the search result comprises: training the original language model as a first language model based on the features of the task; and inputting the first language model into the neural architecture search to obtain the search result.

Clause 4: The method of Clause 3, wherein inputting the first language model into the neural architecture search to obtain the search result comprises: extracting common knowledge in the original language model as a first knowledge loss; extracting knowledge corresponding to the task in the first language model as a second knowledge loss of the first language model; and performing a search in the neural architecture search based on the first knowledge loss and the second knowledge loss to obtain the search result.

Clause 5: The method of Clause 4, wherein performing the search in the neural architecture search based on the first knowledge loss and the second knowledge loss to obtain the search result comprises: determining prompt information based on the first knowledge loss and the second knowledge loss; searching for a model indicated by the prompt information in an architecture search space corresponding to the neural architecture search; and determining the model indicated by the prompt information as the target language model.

Clause 6: The method of Clause 5, wherein determining the prompt information based on the first knowledge loss and the second knowledge loss comprises: establishing cross-task relationships based on the first knowledge loss and the second knowledge loss in a knowledge aggregator, wherein the cross-task relationships are used to indicate relationships among multiple tasks; and determining the prompt information based on the cross-task relationships.

Clause 7: The method of Clause 6, wherein establishing the cross-task relationships based on the first knowledge loss and the second knowledge loss in the knowledge aggregator comprises: recording a first knowledge loss sequence of the original language model and a second knowledge loss sequence of the first language model in the knowledge aggregator, wherein the first knowledge loss sequence includes a knowledge loss of the original language model at at least one moment of training, the second knowledge loss sequence includes a second knowledge loss of the first language model at the at least one moment of training; clustering multiple tasks to obtain at least one meta-task group based on the first knowledge loss sequence of the original language model and the second knowledge loss sequence of the first language model, wherein the meta-task group includes at least two tasks whose similarity degree is greater than a first threshold; performing normalization based on a target value of the meta-task group to obtain a weight of the meta-task group, wherein the target value is used to indicate an average classification performance of the meta-task group; and establishing the cross-task relationships based on the weight of the meta-task group.

Clause 8: The method of Clause 4, wherein: extracting the common knowledge in the original language model as the first knowledge loss comprises extracting the common knowledge in the original language model as the first knowledge loss in a knowledge decomposer; and extracting the knowledge corresponding to the task in the first language model as the second knowledge loss including extracting the knowledge corresponding to the task in the first language model as the second knowledge loss in the knowledge decomposer.

Clause 9: The method of Clause 8, wherein the knowledge decomposer comprises a set of probe classifiers obtained by training the original language model and the first language model.

Clause 10: The method of Clause 3, wherein training the original language model as the first language model based on the features of the task comprises: adding target task parameters of the task to the original language model; and training the target task parameters on a newly added corpus of the task to obtain the first language model.

Clause 11: The method of Clause 10, wherein parameters of the original language model remain unchanged when training the target task parameters on the newly added corpus of the task.

Clause 12: The method of any one of Clauses 1-10, wherein the original language model is obtained from training using an amount of data that is larger than a second threshold, and a number of parameters of the original language model is larger than a third threshold.

Clause 13: The method of any one of Clauses 1-10, wherein the original language model comprises a BERT.

Clause 14: The method of any one of Clauses 1-10, wherein the task comprises a downstream task of the original language model.

Clause 15: A model processing method comprising: obtaining textual information uploaded to a target platform; determining a task corresponding to the textual information, wherein the task is processed by an original language model, and a target language model is obtained by converting the original language model based on features of the task; processing the textual information based on the target language model to obtain a textual processing result; and outputting the textual processing result to the target platform.

Clause 16: The method of Clause 15, wherein the textual information comprises textual transaction information that is uploaded to a transaction platform when the target platform is the transaction platform.

Clause 17: The method of Clause 16, wherein the textual transaction information comprises at least one of: textual query information for querying a transaction object; textual information associated with a transaction operation performed by the transaction object; textual evaluation information for evaluating the transaction object; and textual search information for querying an associated object related to the transaction object.

Clause 18: The method of Clause 15, further comprising: inputting features of the task into a neural architecture search to obtain a search result; and determining the target language model based on the search result.

Clause 19: The method of Clause 18, wherein inputting the features of the task into the neural architecture search to obtain the search result comprises: training the original language model as a first language model based on the features of the task; and inputting the first language model into the neural architecture search to obtain the search result.

Clause 20: The method of Clause 19, wherein inputting the first language model into the neural architecture search to obtain the search result comprises: extracting common knowledge in the original language model as a first knowledge loss; extracting knowledge corresponding to the task in the first language model as a second knowledge loss of the first language model; and performing a search in the neural architecture search based on the first knowledge loss and the second knowledge loss to obtain the search result.

Clause 21: The method of Clause 19, wherein training the original language model as the first language model based on the features of the task comprises: adding target task parameters of the task to the original language model; and training the target task parameters on a newly added corpus of the task to obtain the first language model.

Clause 22: A model processing method comprising: receiving textual input information, wherein the textual input information is collected based on at least one text collector associated with a textual processing system; determining a task corresponding to the textual input information, and reading a target language model, wherein the task is processed by an original language model, and the target language model is obtained by converting the original language model based on features of the task; processing the textual input information based on the target language model that is read to obtain a textual processing result; and outputting the textual processing result.

Clause 23: The method of Clause 22, wherein the textual processing system is deployed on a robot, and the robot is used for performing textual interactions.

Clause 24: The method of Clause 23, further comprising: inputting features of the task into a neural architecture search to obtain a search result; and determining the target language model based on the search result.

Clause 25: The method of Clause 24, wherein inputting features of the task into the neural architecture search to obtain the search result comprises: training the original language model as a first language model based on the features of the task; and inputting the first language model into the neural architecture search to obtain the search result.

Clause 26: The method of Clause 25, wherein inputting the first language model into the neural architecture search to obtain the search result comprises: extracting common knowledge in the original language model as the first knowledge loss; extracting common knowledge in the original language model as a first knowledge loss; extracting knowledge corresponding to the task in the first language model as a second knowledge loss of the first language model; and performing a search in the neural architecture search based on the first knowledge loss and the second knowledge loss to obtain the search result.

Clause 27: The method of Clause 25, wherein training the original language model as the first language model based on the features of the task comprises: adding target task parameters of the task to the original language model; and training the target task parameters on a newly added corpus of the task to obtain the first language model.

Clause 28: A model processing method comprising: obtaining an original language model responsive to a target request sent by a client, wherein the target request includes a task that needs to be processed by the original language model; converting the original language model based on features of the task to obtain a target language model; and sending the target language model to the client, wherein the target language model is used to process the task on the client.

Clause 29: A model processing method comprising: obtaining an original language model; determining a task that needs to be processed by the original language when the original language model satisfies a target condition, and converting the original language model based on features of the task to obtain a target language model for processing the task; and prohibiting the original language model from being converted when the original language model does not satisfy the target condition.

Clause 30: The method of Clause 29, wherein after obtaining the original language model, the method further comprises: determining an amount of training data after obtaining the original language model, wherein the training data is used for training to obtain the original language model; determining that the original language model satisfies the target condition when the amount of data exceeds a target threshold; and determining that the original language model does not satisfy the target condition when the amount of data does not exceed the target threshold.

Clause 31: A model processing method comprising: obtaining an original language model; determining a task that needs to be processed by the original language model, and sending a configuration template associated with features of the task to a client; and obtaining configuration parameters that are obtained by the client based on the configuration template, and converting the original language model based on the configuration parameters to obtain a target language model for processing the task.

Clause 32: The method of Clause 31, wherein obtaining the configuration parameters that are obtained by the client based on the configuration template comprises: obtaining a first knowledge loss, wherein the first knowledge loss is common knowledge extracted by the client from the original language model based on the configuration template; and obtaining a second knowledge loss, wherein the second knowledge loss is knowledge corresponding to the task extracted from a first language model by the client based on the configuration template, and the first language model is obtained by training the original language model based on the features of the task.

Clause 33: The method of Clause 32, wherein converting the original language model based on the configuration parameters to obtain the target language model for processing the task comprises: performing a search in a neural architecture search based on the first knowledge loss and the second knowledge loss to obtain a search result; and determining the target language model based on the search result.

Clause 34: A model processing apparatus comprising: a first acquisition unit used for obtaining an original language model; a first determination unit used for determining a task that needs to be processed by the original language model; and a conversion unit used for converting the original language model based on features of the task to obtain a target language model used to process the task.

Clause 35: A model processing apparatus comprising: a second acquisition unit used for obtaining textual information uploaded to a target platform; a second determination unit used for determining a task corresponding to the textual information, wherein the task is processed by the original language model, and a target language model is obtained by converting the original language model based on features of the task; a first processing unit used for processing textual input information based on the target language model to obtain a textual processing result; and a first output unit used for outputting the textual processing result to the target platform.

Clause 36: A model processing apparatus comprising: a receiving unit used for receiving textual input information, wherein the textual input information is collected based on at least one text collector associated with a textual processing system; and a third determination unit used for determining that a task corresponds to the textual input information and reading a target language model, wherein the task is processed by the original language model, and the target language model is obtained by converting the original language model based on features of the task; a second processing unit used for processing the textual input information using the target language model to obtain a textual processing result; and a second output unit used for outputting the textual processing result.

Clause 37: A storage medium, wherein the storage medium comprises a stored program, and a device where the storage medium is located is controlled to perform the following steps when the program is run by a processor: obtaining an original language model; determining a task that needs to be processed by the original language model; and converting the original language model based on features of the task to obtain a target language model for processing the task.

Clause 38: A processor, wherein the processor is used to run the program, and the following steps are performed when the program is running: obtaining an original language model; determining a task that needs to be processed by the original language model; and converting the original language model based on features of the task to obtain a target language model for processing the task.

Clause 39: A mobile terminal comprising: a processor; a memory coupled to the processor and used for providing the processor with instructions for processing the following processing steps: obtaining an original language model; determining a task that needs to be processed by the original language model; and converting the original language model based on features of the task to obtain a target language model for processing the task.

What is claimed is:

1. A method implemented by a computing device, the method comprising:
obtaining an original language model;
determining a task that needs to be processed by the original language model; and
converting the original language model based on features of the task to obtain the target language model used for processing the task.

2. The method of claim 1, wherein converting the original language model based on the features of the task to obtain the target language model used for processing the task comprises:
inputting features of the task into a neural architecture search to obtain a search result; and
determining the target language model based on the search result.

3. The method of claim 2, wherein inputting the features of the task into the neural architecture search to obtain the search result comprises:
training the original language model as a first language model based on the features of the task; and
inputting the first language model into the neural architecture search to obtain the search result.

4. The method of claim 3, wherein inputting the first language model into the neural architecture search to obtain the search result comprises:
extracting common knowledge in the original language model as a first knowledge loss;
extracting knowledge corresponding to the task in the first language model as a second knowledge loss of the first language model; and
performing a search in the neural architecture search based on the first knowledge loss and the second knowledge loss to obtain the search result.

5. The method of claim 4, wherein performing the search in the neural architecture search based on the first knowledge loss and the second knowledge loss to obtain the search result comprises:
determining prompt information based on the first knowledge loss and the second knowledge loss;
searching for a model indicated by the prompt information in an architecture search space corresponding to the neural architecture search; and
determining the model indicated by the prompt information as the target language model.

6. The method of claim 5, wherein determining the prompt information based on the first knowledge loss and the second knowledge loss comprises:
establishing cross-task relationships based on the first knowledge loss and the second knowledge loss in a knowledge aggregator, wherein the cross-task relationships are used to indicate relationships among multiple tasks; and
determining the prompt information based on the cross-task relationships.

7. The method of claim 6, wherein establishing the cross-task relationships based on the first knowledge loss and the second knowledge loss in the knowledge aggregator comprises:
recording a first knowledge loss sequence of the original language model and a second knowledge loss sequence of the first language model in the knowledge aggregator, wherein the first knowledge loss sequence includes a knowledge loss of the original language model at at least one moment of training, the second knowledge loss sequence includes a second knowledge loss of the first language model at the at least one moment of training;
clustering multiple tasks to obtain at least one meta-task group based on the first knowledge loss sequence of the original language model and the second knowledge loss sequence of the first language model, wherein the meta-task group includes at least two tasks whose similarity degree is greater than a first threshold;
performing normalization based on a target value of the meta-task group to obtain a weight of the meta-task group, wherein the target value is used to indicate an average classification performance of the meta-task group; and
establishing the cross-task relationships based on the weight of the meta-task group.

8. The method of claim 4, wherein:
extracting the common knowledge in the original language model as the first knowledge loss comprises extracting the common knowledge in the original language model as the first knowledge loss in a knowledge decomposer; and
extracting the knowledge corresponding to the task in the first language model as the second knowledge loss including extracting the knowledge corresponding to the task in the first language model as the second knowledge loss in the knowledge decomposer.

9. The method of claim 8, wherein the knowledge decomposer comprises a set of probe classifiers obtained by training the original language model and the first language model.

10. The method of claim 3, wherein training the original language model as the first language model based on the features of the task comprises:
adding target task parameters of the task to the original language model; and
training the target task parameters on a newly added corpus of the task to obtain the first language model.

11. The method of claim 10, wherein parameters of the original language model remain unchanged when training the target task parameters on the newly added corpus of the task.

12. One or more computer readable media storing executable instructions that, when executed by one or more processors, cause the one or more processors to perform acts comprising:
obtaining textual information uploaded to a target platform;
determining a task corresponding to the textual information, wherein the task is processed by an original language model, and a target language model is obtained by converting the original language model based on features of the task;
processing the textual information based on the target language model to obtain a textual processing result; and
outputting the textual processing result to the target platform.

13. The one or more computer readable media of claim 12, wherein the textual information comprises textual transaction information that is uploaded to a transaction platform when the target platform is the transaction platform.

14. The one or more computer readable media of claim 13, wherein the textual transaction information comprises at least one of:
textual query information for querying a transaction object;
textual information associated with a transaction operation performed by the transaction object;
textual evaluation information for evaluating the transaction object; and
textual search information for querying an associated object related to the transaction object.

15. The one or more computer readable media of claim 12, the acts further comprising:
inputting features of the task into a neural architecture search to obtain a search result; and
determining the target language model based on the search result.

16. The one or more computer readable media of claim 15, wherein inputting the features of the task into the neural architecture search to obtain the search result comprises:
training the original language model as a first language model based on the features of the task; and
inputting the first language model into the neural architecture search to obtain the search result.

17. The one or more computer readable media of claim 16, wherein inputting the first language model into the neural architecture search to obtain the search result comprises:
extracting common knowledge in the original language model as a first knowledge loss;
extracting knowledge corresponding to the task in the first language model as a second knowledge loss of the first language model; and
performing a search in the neural architecture search based on the first knowledge loss and the second knowledge loss to obtain the search result.

18. The one or more computer readable media of claim 17, wherein training the original language model as the first language model based on the features of the task comprises:
adding target task parameters of the task to the original language model; and
training the target task parameters on a newly added corpus of the task to obtain the first language model.

19. An apparatus comprising:
one or more processors; and
memory storing executable instructions that, when executed by the one or more processors, cause the one or more processors to perform acts comprising:
receiving textual input information, wherein the textual input information is collected based on at least one text collector associated with a textual processing system;
determining a task corresponding to the textual input information, and reading a target language model, wherein the task is processed by an original language model, and the target language model is obtained by converting the original language model based on features of the task;
processing the textual input information based on the target language model that is read to obtain a textual processing result; and
outputting the textual processing result.

20. The apparatus of claim 19, the acts further comprising:
inputting features of the task into a neural architecture search to obtain a search result; and
determining the target language model based on the search result.
